(19) United States
(12) Patent Application Publication
(10) Pub. No.: US 2016/0155296 A1
(43) Pub. Date: Jun. 2, 2016

(54) Methods of Administering Wagering Games of Roulette with Progressive Side Wagers

(71) Applicant: Bally Gaming, Inc., Las Vegas, NV (US)

(72) Inventors: Gabriel A. Baron, Henderson, NV (US); Roger M. Snow, Las Vegas, NV (US)

(21) Appl. No.: 14/558,511

(22) Filed: Dec. 2, 2014

(51) Int. Cl. G07F 17/32

(52) U.S. Cl. CPC G07F 17/3244

(57) ABSTRACT

Methods of administering wagering games may involve accepting a wager from a player on a game of roulette and receiving indication of a predicted roulette outcome. The predicted roulette outcome may be a number from a set of numbers, such as, for example, zero to thirty-six or from zero to thirty-six and double zero. At least a portion of the wager may be transferred to a progressive pot. A plurality of roulette outcomes may be generated, each roulette outcome being independently randomized. The wager may be resolved by comparing each roulette outcome to the predicted roulette outcome. A payout on the wager may be paid from the progressive pot to the player when at least one roulette outcome is the same as the predicted roulette outcome. An amount of the payout may increase nonlinearly as a number of roulette outcomes matching the predicted roulette outcome increases.

### FIELD

This disclosure relates generally to methods of administering wagering games for casinos and other gaming establishments, and related systems and apparatuses. More specifically, disclosed embodiments relate to methods of administering games of roulette involving progressive side wagers.

### BACKGROUND

Roulette is a popular wagering game played in casinos and other gaming establishments. Avid players are generally open to, and sometimes specifically seek out, new and more interesting ways to play roulette, particularly when the reward for a winning outcome at the end of a round of play, or the odds of achieving a winning outcome, may be enhanced.

For example, U.S. Pat. No. 5,540,442, issued Jul. 30, 1996, to Oreslli et al., discloses a roulette game in which an optional side bet based predicting the number of a roulette outcome may be placed. One roulette outcome is generated using the roulette wheel and another roulette outcome is generated using a random number generator. The side bet is won when both outcomes are the same number.

U.S. Pat. No. 7,686,306, issued Mar. 30, 2010, to Au-Yeung, discloses a roulette game in which a bet predicting the outcomes of a roulette spin and two other random events, which may involve randomly generating numbers from a set of numbers or throwing one or more dice, may be placed. The roulette outcome is generated and the other random events also produce results. The bet is won when the player successfully forecasts the outcome of all three events.

U.S. Pat. No. 7,901,280, issued Mar. 8, 2011, to Jarvis et al., discloses a slots-style roulette game in which players may select the number of roulette outcomes to be generated, the number of paylines on which those outcomes may appear, and the outcomes to which credits should be allocated. The total wager is calculated by multiplying the amount of credits applied to predicted outcomes by the number of roulette outcomes to be generated and the number of paylines selected, such that each credit selection constitutes a separate wager on multiple roulette outcomes. An individual wager is won when any roulette outcome on an active payline matches the prediction associated with that wager. The payout increases linearly as the number of outcomes matching a given prediction increases (i.e., two matches pays two of the listed payout and three matches pays three of the listed payout).

U.S. Patent App. Pub. No. 2013/0214486, published Aug. 22, 2013, to Shelburn et al., discloses a roulette game in which an optional doubleball wager predicting a roulette outcome may be placed. Two roulette outcomes are generated by propelling two balls onto the same roulette wheel. The doubleball wager is won when both balls come to rest in the same pocket. The doubleball wager may be a progressive wager.

### BRIEF SUMMARY

In some embodiments, methods of administering wagering games may involve accepting a wager from a player on a game of roulette by receiving authorization at a control circuit to allocate funds to the wager and receiving electronic indication of a predicted roulette outcome. The predicted roulette outcome may be a number selected from a set of numbers. Authorization to transfer at least a portion of the wager to a progressive pot may be generated at the control circuit. A plurality of roulette outcomes may be generated, each roulette outcome being independently randomized. The control circuit may resolve the wager by comparing each roulette outcome of the plurality of roulette outcomes to the predicted roulette outcome. The control circuit may generate electronic authorization to pay a payout on the wager from the progressive pot to the player when at least one roulette outcome is the same as the predicted roulette outcome. An amount of the payout may increase nonlinearly as a number of roulette outcomes matching the predicted roulette outcome increases.

In other embodiments, methods of administering wagering games may involve accepting a roulette wager from a player on a game of roulette by receiving authorization at a control circuit to allocate funds to the roulette wager and receiving electronic indication of a predicted characteristic of a roulette outcome. The predicted characteristic may be at least one of a number from zero to thirty-six or from zero to thirty-six and double zero, a color, and a group of numbers within a range from zero to thirty-six or from zero to thirty-six and double zero. In accordance with one or more embodiments, the predicted characteristic may include other numbers and ranges of numbers than zero, double-zero and one to thirty-six. For example, a mini-roulette game may use fewer numbers. A side wager may be accepted from the player on the game of roulette by receiving authorization at a control circuit to allocate funds to the wager and receiving electronic indication of a predicted roulette outcome. The predicted roulette outcome may be a number from zero to thirty-six or from zero to thirty-six or double zero. The control circuit may generate authorization to transfer at least a portion of the side wager to a progressive pot. A set of roulette outcomes comprising a primary roulette outcome and at least one ancillary roulette outcome may be generated, each roulette outcome of the set of roulette outcomes being independently randomized. The control circuit may resolve the roulette wager by comparing the primary roulette outcome to the predicted characteristic associated with the roulette wager. The control circuit may resolve the side wager by comparing each roulette outcome of the set of roulette outcomes to the predicted roulette outcome associated with the side wager. The control circuit may generate electronic authorization to pay a payout on the side wager from the progressive pot to the player when at least one roulette outcome of the set of roulette outcomes is the same as the predicted roulette outcome. An amount of the payout may increase linearly or nonlinearly as a number of roulette outcomes of the set of roulette outcomes matching the predicted roulette outcome increases.

In still other embodiments, systems for administering wagering games over networks may include a server configured to connect to a network, the server comprising a control circuit. The server may be programmed to accept a wager over the network from a player on a game of roulette by receiving authorization to allocate funds to the wager and receive electronic indication of a predicted roulette outcome. The predicted roulette outcome may be a number selected from a set of numbers. The server may be programmed to generate authorization to transfer at least a portion of the wager to a progressive pot. The server may be programmed to generate a plurality of roulette outcomes, each roulette outcome being independently randomized, and resolve the wager by comparing each roulette outcome to the predicted roulette outcome. The server may be programmed to generate electronic authorization to pay a payout on the wager from the progressive pot to the player when at least one roulette outcome is the same as the predicted roulette outcome. An amount of the payout may increase linearly or nonlinearly as a number of roulette outcomes matching the predicted roulette outcome increases.

### BRIEF DESCRIPTION OF THE DRAWINGS

While this disclosure concludes with claims particularly pointing out and distinctly claiming specific embodiments, various features and advantages of embodiments within the scope of this disclosure may be more readily ascertained from the following description when read in conjunction with the accompanying drawings, in which:

FIG. 1 is a flowchart diagram of a method of administering a wagering game, according to an embodiment of this disclosure;

FIG. 2 is a diagram of a playing surface for implementation of a method of administering a wagering game, according to an embodiment of this disclosure;

FIG. 3 is a display layout that may be used in connection with a playing surface for implementation of a method of administering a wagering game, according to another embodiment of the present disclosure;

FIG. 4 is a perspective view of a gaming table configured for implementation of embodiments of wagering games in accordance with this disclosure;

FIG. 5 is a perspective view of an individual electronic gaming device configured for implementation of embodiments of wagering games in accordance with this disclosure;

FIG. 6 is a perspective view of a table configured for implementation of embodiments of wagering games in accordance with this disclosure;

FIG. 7 is a perspective view of another embodiment of a table configured for implementation of embodiments of wagering games in accordance with this disclosure, wherein the implementation includes a virtual croupier;

FIG. 8 is a perspective view of another embodiment of a table configured for implementation of embodiments of wagering games in accordance with the present disclosure, wherein the implementation includes a virtual croupier;

FIG. 9 is a schematic block diagram of a gaming system for implementing embodiments of wagering games in accordance with this disclosure;

FIG. 10 is a schematic block diagram of a gaming system for implementing embodiments of wagering games including a live croupier feed;

FIG. 11 is a block diagram of a computer for acting as a gaming system for implementing embodiments of wagering games in accordance with this disclosure;

FIG. 12 illustrates an embodiment of data flows between various applications/services for supporting the game, feature or utility of the present disclosure for mobile/interactive gaming; and

FIG. 13 is a schematic of a scratch card implementation of a wagering game in accordance with this disclosure.

### DETAILED DESCRIPTION

The illustrations presented in this disclosure are not meant to be actual views of any particular act in a method, apparatus, system, or component thereof, but are merely idealized representations employed to describe illustrative embodiments. Thus, the drawings are not necessarily to scale. Additionally, elements common between figures may retain the same or similar numerical designation. Elements with the same number, but including a different alphabet character as a suffix should be considered as multiple instantiations of substantially similar elements and may be referred generically without an alphabet character suffix.

The terms “gaming,” “gambling,” or the like, refer to activities, games, sessions, rounds, hands, rolls, operations, and other events related to wagering games the outcome of which is at least partially based on one or more random events (“chance” or “chances”), and on which wagers may be placed by a player. In addition, the words “wager,” “bet,” “bid,” or the like, refer to any type of wager, bet, or gaming venture that is placed on random events, whether of monetary or non-monetary value. Points, credits, and other items of value may be purchased, earned, or otherwise issued prior to beginning the wagering game. In some embodiments, purchased points, credits, or other items of value may have an exchange rate that is not one-to-one to the currency used by the user. For example, a wager may include money, points, credits, symbols, or other items that may have some value related to a wagering game. Wagers may be placed in wagering games that involve the risk of real-world monetary value for the potential of payouts with real-world monetary value (e.g., the “play-for-pay,” such as “house-banked” and “player-banked,” configurations, each of which is described in more detail below) or in wagering games that involve no real-world monetary risks for the player (e.g., the “play-for-fun” and “social play-for-fun” configurations described in more detail below).

As used herein, the term “wager” includes any form of wagering value, including money, casino chips, other physical means for payment, and online or remote electronic authorization of a wager in any acceptable form to the casino or online or virtual game host. Also included are physical representations of money (e.g., casino chips) at a local game, as well as virtual representations of money in the form of electronic authorizations of a transfer of money and digital representations of money (e.g., digital representations of bills or coins, digital representations of chips, numerical quantities of money, numerical quantities of points, or numerical quantities of credits) at a local or remote electronic gaming device. As used herein, the term “wagering element” means and includes objects and symbols used to signify the acceptance of a wager. For example, physical wagering elements include physical money (e.g., bills and coins) and physical wagering tokens (e.g., casino chips), which may or may not be redeemable for monetary value and may or may not include electronic identifiers (e.g., RFID chips) embedded within the tokens, enabling electronic sensing and tracking of wagering. Virtual wagering elements include, for example, images (e.g., images of money or poker chips) and text (e.g., a string of numbers), which may or may not be redeemable for monetary value. In the “play-for-fun” and “social play-for-fun” configurations, a “wager” may not have a cash value (i.e., a real-world monetary value).

For the purposes of this description, it will be understood that when an action related to accepting wagers, making payouts, generating roulette outcomes, accepting selection of roulette outcomes, or other actions associated with a player or a croupier is described herein, and such description includes a player or a croupier taking the action, the results of the action may be computer generated and may be displayed on a live or virtual table or electronic display, and, if applicable, the reception or detection of such an action in an electronic form where player and croupier choices, selections, or other actions are received at an electronic interface. This further includes the results of a virtual croupier and virtual players, where the actions described are actually generated by a computer (typically associated with an online game). By way of a further example, if generating a roulette outcome is described herein, the description includes (but is not limited to) the following: introduction of a physical ball or other outcome identifier into a spinning, physical roulette wheel and permitting the ball to come to rest on a roulette outcome; and the generation and transmission of an electronic indication or representation of a roulette outcome from a game play source or server to an electronic receiver, where the receiver may be at a table (using a virtual roulette wheel) including players and/or virtual players and/or a croupier or virtual croupier, on a gaming terminal, at a public display in a casino, at a remote location (e.g., using online or Internet game play), or at other locations. Also included is the representation of a roulette wheel or roulette outcome on a display or displays, and, if applicable to the action described, an electronic reception of an indication that the roulette outcome has been received, selected, or otherwise interacted with at a location associated with a player, or, associated with a virtual player. In addition, generating a roulette outcome may refer to revealing a representation of a roulette outcome on a scratch-off card (also referred to as “scratchers”).

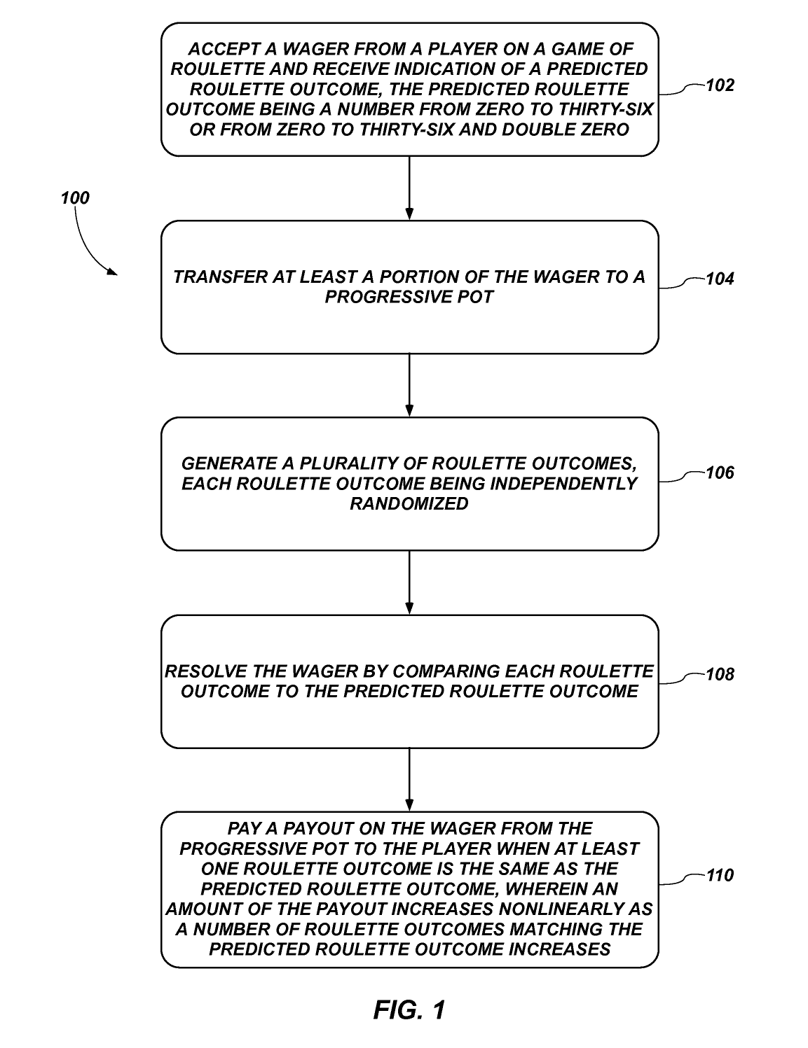

Referring to FIG. 1, a flowchart diagram of a method 100 of administering a wagering game is shown. The method 100 may involve accepting a wager from a player on a game of roulette and receiving indication of a predicted roulette outcome, as indicated at operation 102. The wager may be, for example, an unconventional roulette wager (e.g., a side wager, a progressive wager, or a bonus wager). The wager may be optional or mandatory. A result of the wager may depend on a comparison between the predicted roulette outcome and each of a plurality, for example, three, of independently randomized roulette outcomes produced during a single round of the wagering game. The predicted roulette outcome may be, for example, a number from zero to thirty-six or from zero to thirty-six and double zero.

In some embodiments, the method 100 may involve receiving an indication of a plurality of predicted roulette outcomes in connection with the wager. For example, a wager corresponding to a split (i.e., predicting two adjoining numbers on a roulette layout), a street (i.e., predicting three numbers on a single, horizontal row), a corner (i.e., predicting four numbers in a square layout), a low bet (i.e., predicting each number from one to eighteen), a high bet (i.e., predicting each number from nineteen to thirty-six), a red or black bet (i.e., predicting each number on a red or black space), an evens or odds bet (i.e., predicting each, nonzero even or odd number), or other groupings of numbers associated with roulette betting may be accepted. In some embodiments, a prediction of each possible roulette outcome (e.g., each number from a zero to thirty-six or from zero to thirty-six and double zero) may be accepted, which may be referred to as a “coverall” wager.

A total amount of the wager may depend on the number of roulette outcomes predicted. For example, an additional wagering unit amount may be accepted for each predicted roulette outcome (e.g., one dollar, two dollars, or five dollars per predicted roulette outcome). More specifically, the total amount of the wager may be equal to the number of predicted roulette outcomes multiplied by a selected wagering amount (e.g., an amount fixed by the game administrator or a player-selected amount greater than an administrator-selected minimum, less than an administrator-selected maximum, or both).

The wager may be accepted, for example, by physically receiving money or a representation of money (e.g., a chip or token) on a designated betting area, by a control circuit receiving a signal from a user interface indicating a wager has been received, or by receiving electronic authorization to charge a player account (e.g., a credit account or a bank account). More specifically, the wager may be accepted, for example, by physically receiving wagering elements (e.g., casino chips) within a wager area on a playing surface of a playing table or by receiving electronic authorization at a control circuit to charge a player account via a player interface or croupier interface, where the player interface may be remotely located from the croupier or game server. As specific, nonlimiting examples, the wager may be accepted by receiving physical wagering elements specific to the player and to the wager (e.g., including markings designating them as connected to the specific wager and colored with a unique color different from other player's wagering elements and other wagering elements accepted for other wagers) or by receiving at a control circuit electronic authorization to allocate funds to the specific wager (e.g., by presenting an interface separate from an interface used to place other roulette wagers and accepting the indication from the specific interface).

The predicted roulette outcome may be received, for example, by visually perceiving, electronically detecting (e.g., using a sensor), or electronically receiving (e.g., at a control circuit via a user interface or croupier interface) an indication of the predicted roulette outcome. More specifically, the predicted roulette outcome may be received by visually perceiving or electronically detecting a position of a physical wagering element on a playing surface of a playing table, which may be associated with one or more predicted roulette outcomes, or by receiving at a control circuit an electronic indication of the outcomes predicted (e.g., via a player or croupier interface).

At least a portion of the wager may be transferred to a progressive pot, as indicated at operation 104. For example, at least a portion of the wagering elements associated with the wager may be segregated in a separate area on a playing surface of a playing table, a total wagered amount may be determined or automatically detected from physical wagering elements (e.g., by visually inspecting and counting the wagering elements or sensing the wagering elements using sensors) and at least a portion of that amount may be added to a progressive meter, or the wagered amount may be accepted at a control circuit and at least a portion of the wagered amount may be added to a progressive meter.

In some embodiments, the progressive pot may be a pooled or linked pot. For example, the progressive pot may include one or more wagers accepted from multiple concurrent wagering games. As another example, the progressive pot may include pooled progressive wagers from those wagering games currently being played and may include accumulated wagers from past wagering games. As specific, nonlimiting examples, the progressive pot may include all the progressive wagers accepted from a group of electronic gaming tables or other local wagering game administration devices at a casino, from multiple groups of remote devices connected to network gaming architecture, or both. In other embodiments, the progressive pot may not be pooled, and awards for the game wager may be limited to the amounts wagered at a respective electronic gaming table, other local wagering game administration device, or group of remote devices.

In some embodiments, the game administrator may take a “rake” (e.g., a commission for the house) on the wager before transferring a remainder of the wager to the progressive pot. The rake may be, for example, a fixed percentage of the wager. More specifically, the percentage of the wager collected for the rake may be, for example, greater than a theoretical house advantage for the underlying game. As another example, the rake may be less than an average house advantage for play of the wagering game by all players, including average and sub-average players, which may be calculated using a historical house advantage for the wagering game (e.g., a house advantage for the wagering game over the last 5, 10, or 15 years for a given casino or other gaming establishment). As specific, nonlimiting examples, the percentage of the wager collected for the rake may be between 3% and 8%, between 4% and 7%, or between 5% and 6%. In other embodiments, the portion of the wager collected for the rake may be a variable percentage of the wager or may be a fixed quantity (e.g., a flat fee) irrespective of the total amount for the wager, a fixed percentage with a cap, or a time based fee for increments of time playing the wagering game. Thus, in lieu of, or in addition to, a rake taken on the wager, the house may be compensated in a number of other ways, including, without limitation, a flat fee per round of play, a percentage of wagers made with or without a cap, rental of a player “seat,” or otherwise as is known in the gaming art. All such compensation may be generally referred to as a “commission.”

All profits for the game administrator may be made from the rake (or rakes or other commission) in some player-banked embodiments. In such embodiments, wagered amounts in excess of the rake are distributed in the form of, for example, a progressive payout. Thus, the profits for the house may be limited. Such limiting of profits for the house and redistribution of wagers back to one or more players may increase the attractiveness of the wagering game to both inexperienced and highly skilled players. Because the amount earned by the house is known, highly skilled players may perceive that their skill will enable them to increase winnings, and inexperienced players may be enticed by the possibility of winning or otherwise earning a portion or all of one or more of the pots. In other embodiments, the house may make profits on the rake and on losses from the bonus wager, including losses resulting from optimal and suboptimal play.

The rake may be maintained in a rake account, and profits for the house may be deducted from the rake account. When and if taken from the wager, the rake may be taken by, for example, collecting physical wagering elements or electronically transferring funds from the wager to a rake account (e.g., as instructed by a game service using casino account servers or as otherwise instructed by a control circuit of a device administering or partially administering the wagering game).

In some embodiments, another wager may be accepted from the player on the game of roulette and indication of a predicted characteristic of a roulette outcome may be received. The other wager may be, for example, a conventional roulette wager (e.g., straight wager, split wager, street wager, corner wager, red wager, black wager, even wager, odd wager, dozen wager). The other wager may be optional or mandatory. A result of the other wager may depend on a comparison between the predicted characteristic of the roulette outcome and one of the plurality of independently randomized roulette outcomes produced during a single round of the wagering game. The other wager may not be a progressive wager, may not be added to a progressive pot, and may not be raked, such that losses on the other wager may be collected by the game administrator. The predicted characteristic of the roulette outcome may be, for example, a number from zero to thirty-six or from zero to thirty-six and double zero, a color, or a group of numbers in the range from zero to thirty-six or from zero to thirty-six and double zero. The other wager may be accepted, and the predicted characteristic of the roulette outcome may be received, by performing any of the acts described previously in connection with accepting the bonus wager and receiving the predicted roulette outcome.

A plurality of roulette outcomes may be generated, and each roulette outcome may be randomized independently from the other roulette outcomes, as indicated at operation 106. The plurality of roulette outcomes may be generated in a single round of the wagering game, and a plurality of roulette outcomes may be generated in each round of the wagering game. One of the roulette outcomes may be, for example, a primary roulette outcome, which may be used to resolve the bonus wager and the other wager. One or more of the other roulette outcomes may be, for example, ancillary roulette outcomes, which may be used to resolve only the bonus wager. A total number of roulette outcomes generated in a given round may be, for example, two, three, four, or even greater. As a specific, nonlimiting example, the total number of roulette outcomes generated in a given round may be three, with one primary roulette outcome and two ancillary roulette outcomes.

In some embodiments, one or more of the plurality of roulette outcomes may be generated by introducing a physical outcome identifier (e.g., a ball) into a physical, spinning roulette wheel and permitting the outcome identifier to come to rest on a roulette outcome. For example, a single outcome identifier may be introduced into a single spinning roulette wheel, the outcome identifier may come to rest on a roulette outcome, and the roulette outcome may be visually perceived or automatically detected (e.g., using one or more sensors) and conveyed to a control circuit. As another example, two outcome identifiers may be introduced onto a single spinning roulette wheel or onto two roulette wheels (e.g., one outcome identifier per wheel), may come to rest on two separately randomized roulette outcomes, and the two roulette outcomes may be visually perceived or automatically detected and conveyed to a control circuit. As yet another example, three outcome identifiers may be introduced onto a single spinning roulette wheel or onto three roulette wheels (e.g., one outcome identifier per wheel), may come to rest on three separately randomized roulette outcomes, and the three roulette outcomes may be visually perceived or automatically detected and conveyed to a control circuit.

In some embodiments, one or more of the plurality of roulette outcomes may be generated utilizing a random number generator (e.g., operated by a control circuit). For example, a single roulette outcome may be generated utilizing a random number generator to produce a randomized number from zero to thirty-six or from zero to thirty-six and double zero. As another example, two roulette outcomes may be generated utilizing a random number generator to produce two, independently randomized numbers from zero to thirty-six or from zero to thirty-six and double zero. As yet another example, three roulette outcomes may be generated utilizing a random number generator to produce three, independently randomized numbers from zero to thirty-six or from zero to thirty-six and double zero.

The bonus wager may be resolved by comparing each roulette outcome to the predicted roulette outcome, as indicated at operation 108. More specifically, each roulette outcome generated in a given round of play may be compared to the roulette outcome or roulette outcomes predicted for that round. The actual roulette outcomes may be compared to the predicted roulette outcome by, for example, visually inspecting the generated roulette outcomes and contrasting them to a visual depiction of the predicted roulette outcome or outcomes (e.g., a list or a betting laying having wagering elements in positions corresponding to the predicted roulette outcomes), by electronically comparing detected (e.g., using sensors) or entered (e.g., utilizing a croupier interface) roulette outcomes to predicted rouletted outcomes stored in memory utilizing a control circuit, by electronically comparing control circuit-generated roulette outcomes to predicted roulette outcomes stored in memory utilizing the control circuit, or by doing some combination of these. In some embodiments, the roulette outcomes generated for the current round and historical information about the game of roulette may be displayed to the player using, for example, the techniques disclosed in U.S. patent application Ser. No. 13/631,598, filed Sep. 28, 2012, for “SYSTEMS, METHODS, AND DEVICES FOR DISPLAYING HISTORICAL ROULETTE INFORMATION,” the disclosure of which is incorporated herein in its entirety by this reference.

A payout on the progressive wager may be paid from the progressive pot to the player when at least one roulette outcome is the same as the predicted roulette outcome, as indicated at operation 110. For example, a payout on the progressive wager may be paid from the progressive pot to the player when one generated roulette outcome matches one of the predicted roulette outcomes, when two generated roulette outcomes match each other and one of the predicted roulette outcomes, when three generated roulette outcomes match each other and one of the predicted roulette outcomes, and so on.

In some embodiments where multiple roulette outcomes were predicted, the same, a single payout may be paid regardless of how many predicted roulette outcomes match with the plurality of generated roulette outcomes. For example, the bonus wager may be won once, meriting a single payout, when one predicted roulette outcome matches one of the plurality of generated roulette outcomes, two predicted roulette outcomes match two different roulette outcomes from the plurality of generated roulette outcomes, three predicted roulette outcomes match three of the plurality of different, generated roulette outcomes, and so on. In other embodiments where multiple roulette outcomes were predicted, multiple payouts may be paid when multiple predicted roulette outcomes match with different roulette outcomes from the plurality of generated roulette outcomes. For example, the bonus wager may be won multiple times, meriting multiple payouts, when two predicted roulette outcomes match two different roulette outcomes from the plurality of generated roulette outcomes, three predicted roulette outcomes match three of the plurality of different, generated roulette outcomes, and so on.

An amount of the payout may increase nonlinearly as a number of roulette outcomes matching the predicted roulette outcome increases, as further indicated at operation 110. For example, the amount of the payout may increase exponentially, randomly, or in a manner not easily mathematically described as a number of generated roulette outcomes matching the predicted roulette outcome increases. As a specific, nonlimiting example, the amount of the payout may be 7:1 when one of the plurality of generated roulette outcomes is the same as one of the predicted outcomes, 100:1 when more than one but fewer than all of the plurality of generated roulette outcomes (e.g., two roulette outcomes) are the same as one of the predicted outcomes, and an entire amount of the progressive pot when all of the plurality of generated roulette outcomes are the same as one of the predicted outcomes.

Awarding the progressive pot or a portion of the progressive pot to a player may involve, for example, crediting a player account with funds from the game pot or distributing physical money or physical representations of money from the game pot to the player. More specifically, the payout may be paid, for example, by physically giving chips to a player on a playing surface of a playing table, by receiving electronic authorization at a control circuit via a dealer interface to transfer funds from an account server to a player account, or automatically generating electronic authorization at the control circuit to transfer funds from an account server to a player account.

In some embodiments, the progressive pot may be seeded with money from the rake account or a reserve account at the beginning of play, after the progressive pot or a portion of the progressive pot has been awarded, or both. In some embodiments, a minimum account balance sufficient to cover expected losses is retained when distributing a progressive payout such that no seed money is required in the progressive pot. For example, the progressive pot may be seeded from the rake account of the house, and the house may maintain an amount of funds in the rake account sufficient to significantly reduce (e.g., to essentially eliminate) the likelihood that any payouts made from the rake account and any seeding amounts withdrawn from the rake account exhaust or overdraw the rake account. In some embodiments, a casino reserve account may be provided to fill the rake account in the event of an overdraw. Such seeding may incentivize players to participate in the wagering game, and specifically to place a bonus wager (e.g., a progressive wager) to be eligible for the progressive payout from the progressive pot. In addition, such seeding may reduce the likelihood that the amount of funds in the progressive pot may be insufficient to cover all the payouts to players. An amount seeded to the progressive pot may be at least as great as the maximum fixed odds payout awardable from the progressive pot for any winning scenario. For example, the amount seeded to the progressive pot may be greater than the number of participating players multiplied by the greatest fixed odds payout winnable from the progressive pot. As a specific, nonlimiting example, the amount seeded to the progressive pot may be $1,000 or greater. The progressive pot may be seeded each time the progressive pot is awarded in its entirety or each time the amount in the progressive pot is lower than the amount seeded when the progressive pot is awarded in its entirety.

When there is no match between the predicted roulette outcome or outcomes and the plurality of generated roulette outcomes, the amount of the bonus wager originally allocated to the progressive pot may remain in the progressive pot in some embodiments. For example, the unraked portion of the bonus wager may remain in the progressive pot to be won in a subsequent round of play when the player does not win the bonus wager. More specifically, the progressive pot balance may be carried forward for the next round of play and so on until a progressive-winning condition occurs during a subsequent round. Thus, the progressive pot may not be awarded at the end of each round of play, but may grow during each successive round in which no player places the bonus wager and successfully predicts one or more of the generated roulette outcomes. However, if one or more progressive payouts are awarded, without exhausting the progressive pot, the progressive pot may be partially reduced until the progressive pot contributions rebuild the progressive pot or the progressive pot is reseeded.

In other embodiments, the amount of the bonus wager originally allocated to the progressive pot, or a portion thereof, may be collected by the game administrator. For example, an additional rake may be taken on the unraked portion of the bonus wager or the unraked portion of the bonus wager may be transferred to the game administrator. Collecting the amount of the bonus wager originally allocated to the progressive pot, or a portion thereof, may be accomplished, for example, by physically retrieving money or chips, decrementing credits from a player credit meter or a progressive pot meter, or granting electronic authorization to transfer funds to a house account. More specifically, collecting the amount of the bonus wager originally allocated to the progressive pot, or a portion thereof, may be accomplished, for example, by physically retrieving chips from the playing surface of a playing table, receiving electronic authorization at a control circuit via a dealer interface to transfer funds from a player account or a progressive pot account to an administrator account server, or automatically generating electronic authorization at the control circuit to transfer funds from the player account or progressive pot account to a house account server.

Payouts may be paid on any other roulette wagers when a characteristic of the randomly generated number and associated color is the same as the predicted characteristics associated with the additional wagers. For example, the other roulette wager may be resolved by comparing the predicted characteristic to the corresponding characteristic of one of the three generated roulette outcomes. More specifically, the other roulette wager may be resolved by comparing the predicted characteristic to the corresponding characteristic of the primary roulette outcome. The amounts of any additional wagers may be collected for the game administrator when the characteristic of the relevant one of the generated roulette outcomes is different from the predicted characteristic associated with the other wagers. Paying the payouts and collecting the additional wagers may be accomplished by performing any of the actions described previously in connection with paying the payout on the bonus wager and collecting the amount of the bonus wager originally allocated to the progressive pot, or a portion thereof.

Various platforms are contemplated that are suitable for implementation of embodiments of wagering games according to this disclosure. For example, embodiments of wagering games may be implemented as live table games with an in-person croupier, electronic gaming machines, partially or fully automated table games, and partially or fully automated, network-administered games (e.g., Internet games) wherein game results may be produced utilizing a control circuit or a live video feed of a croupier administering a game from a remote studio.

As previously noted, any of the present methods and games may be played as a live casino roulette game, as a hybrid casino table roulette game (with virtual roulette wheels or otherwise virtual outcomes, virtual chips, or both), on a multiplayer electronic platform (as disclosed in U.S. patent application Ser. No. 10/764,827, filed Jan. 26, 2004, published as U.S. Patent Application Publication No. 2005/0164759 on Jul. 28, 2005, now abandoned; U.S. patent application Ser. No. 10/764,994, filed Jan. 26, 2004, now U.S. Pat. No. 7,661,676, issued Feb. 16, 2010; and U.S. patent application Ser. No. 10/764,995, filed Jan. 26, 2004, now U.S. Pat. No. 8,272,958, issued Sep. 25, 2012; the disclosure of each of which applications and patents is incorporated herein in its entirety by this reference), on a personal computer for practice, on a hand held game for practice, on a legally authorized site on the Internet, or on a play-for-fun site on the Internet.

For example, in one embodiment, the players may be remotely located from a live croupier, and a live croupier and a roulette table may be displayed to players on their monitors via a video feed. The players' video feeds may be transmitted to the croupier and may also be shared among the players at the table. In a sample embodiment, a central station may include a plurality of betting-type game devices and an electronic camera for each game device. A plurality of player stations, remotely located with respect to the central station, may each include a monitor, for displaying a selected game device at the central station, and input means, for selecting a game device and for placing a bet by a player at the player's station relating to an action involving an element of chance to occur at the selected game device. Further details on gambling systems and methods for remotely-located players are disclosed in U.S. Pat. No. 6,755,741 B1, issued Jun. 29, 2004, titled “GAMBLING GAME SYSTEM AND METHOD FOR REMOTELY-LOCATED PLAYERS,” the disclosure of which is incorporated herein in its entirety by this reference.

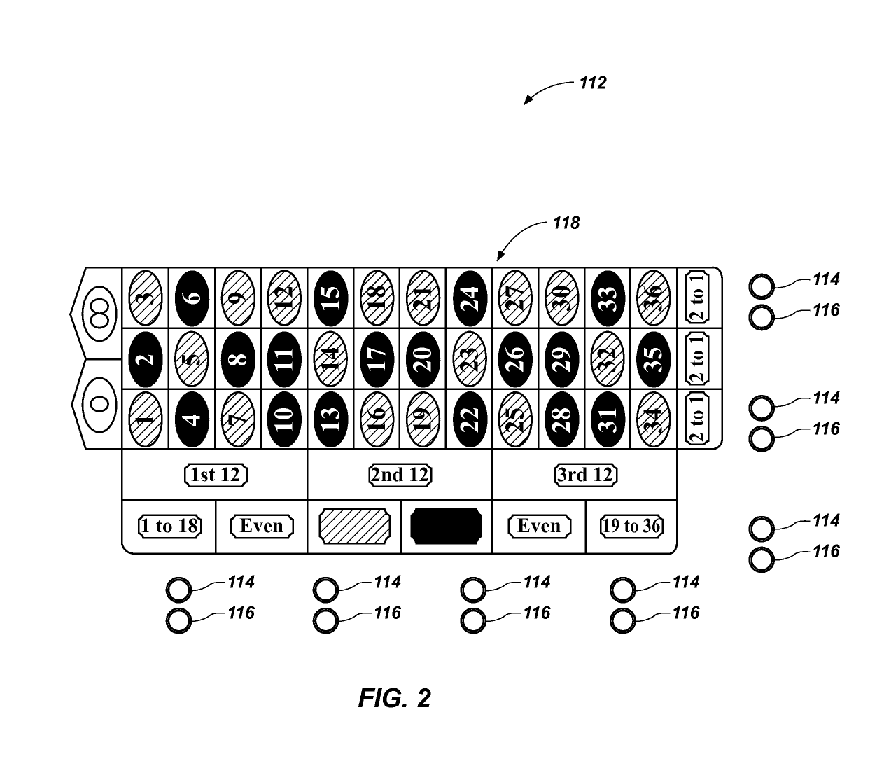

FIG. 2 is a diagram of a playing surface 112 for implementing wagering games within the scope of this disclosure. Such an implementation may be, for example, a felt layout on a physical gaming table or an electronic representation on an electronic display. The playing surface 112 may include bonus wager areas 114 at multiple player positions from which wagering elements specifically associated with the bonus wager described previously in connection with FIG. 1 may be retrieved. The playing surface 112 may also include roulette wager areas 116 at multiple player positions from which wagering elements associated with conventional roulette wagering may be retrieved.

In some embodiments, an electronic bet sensor may be provided to electronically recognize the placement of a specific type of chip (e.g., bonus wager or conventional roulette wager) of a fixed denomination. In some embodiments, the electronic bet sensor may also be configured to determine the denomination of the chip. In still other embodiments, the electronic bet sensor may be able to detect one or more denominations of a plurality of stacked chips included in the wager. In some embodiments, the wager can be any size within house limits.

The playing surface 112 may further include a wagering area 118, in which the bonus wager, conventional roulette wagers, and any other wagers may be accepted. The wagering area 118 may be the same as or similar to wagering areas described in U.S. patent application Ser. No. 13/631,598, filed Sep. 28, 2012, for “SYSTEMS, METHODS, AND DEVICES FOR DISPLAYING HISTORICAL ROULETTE INFORMATION.” Briefly, the wagering area 118 may be configured for acceptance of bonus, odds, evens, red, black, split, box, specific number and color, and other roulette bets, wherein the receipt of a wagering element within a specific area, on a border between areas, or at an intersection among areas may reflect receipt of a predicted roulette outcome or a predicted characteristic of a roulette outcome. In some embodiments, the playing surface 112 may include an area for electronically showing the outcome of randomly generated roulette outcomes or a roulette wheel into which a ball may be introduced to randomly generate a roulette outcome.

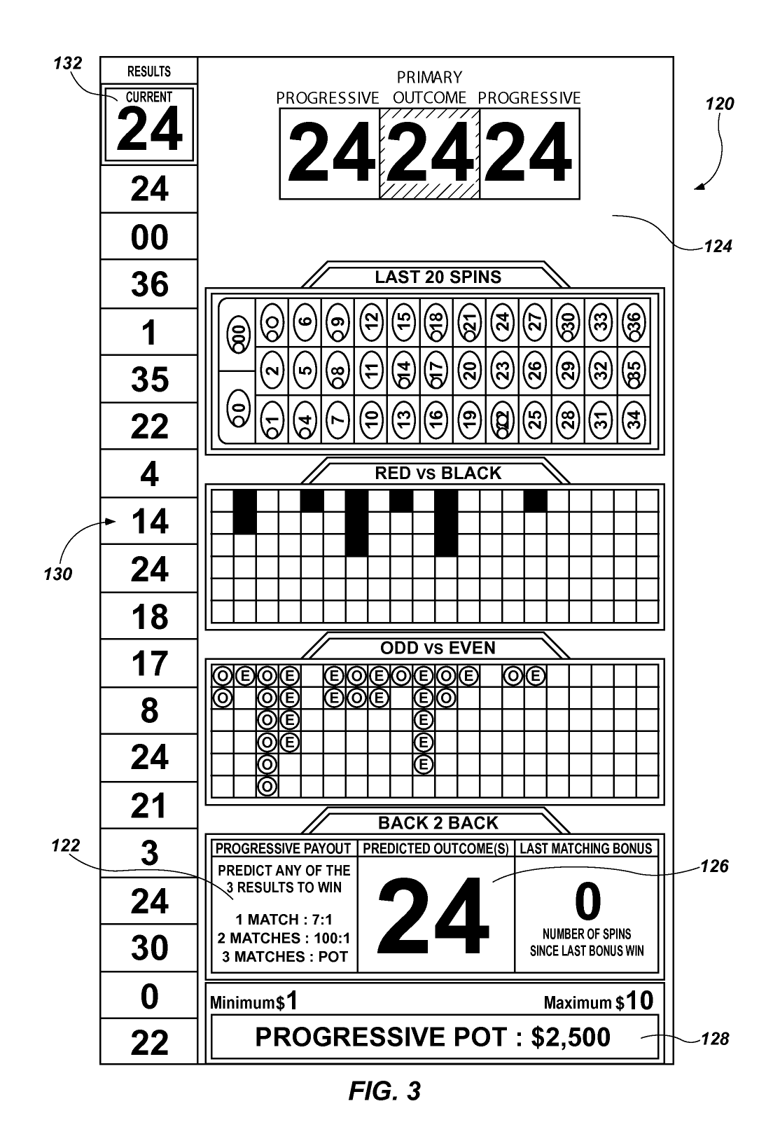

FIG. 3 is a display layout 120 that may be used in connection with a playing surface 112 (see FIG. 2) for implementation of a method of administering a wagering game, according to another embodiment of the present disclosure. Such an implementation may be a traditional roulette game utilizing a felt surface and an electronic display or solely an electronic representation on an electronic display.

The electronic display may include a display layout 120. The display layout 120 may include a progressive pay table area 122, which may be, for example, a section of a display electronically showing the potential payouts from the bonus wager. The display layout 120 may further include an outcome display area 124 in which the three, independently randomized roulette outcomes for the current round of play may be displayed. A bonus wager prediction area 126 may display the current predicted roulette outcome for which matches with the generated roulette outcomes may result in a progressive payout. A pot tracking area 128 may display the current total available to win from the progressive pot.

The display layout 120 may display historical information on at least the primary outcomes, and optionally of the ancillary outcomes, of the game of roulette in multiple formats, as described in U.S. patent application Ser. No. 13/631,598, filed Sep. 28, 2012, for “SYSTEMS, METHODS, AND DEVICES FOR DISPLAYING HISTORICAL ROULETTE INFORMATION.” Briefly, the display layout 120 may display the numbers and colors for the current and preceding outcomes and may visually represent streaks in specific outcomes (e.g., 24 black, 36 red, etc.) and characteristics of outcomes (e.g., odds, evens, red, black, green). The display layout 120 may have a vertical column 130 of historical game outcomes, in the order in which the outcomes occurred, the newest being at the top of the column The display layout 120 may include a current primary outcome area 132, which may display the outcome determining whether any of the conventional roulette wagers may be won or lost.

With collective reference to FIGS. 2 and 3, the results of actions performed when administering games in accordance with this disclosure may be reflected on the playing surface 112, the display layout 120, or both. For example, a bonus wager may be accepted from a player, indication of a predicted roulette outcome may be received, and at least a portion of the bonus wager may be transferred to a progressive pot, which may be reflected by the presence of one or more wagering elements of a designated type located on one or more positions on the wagering area 118, the display of one or more numbers in the bonus wager prediction area 126, the display of an incrementally higher amount in the pot tracking area 128, or any combination of these. The amount by which the progressive pot may increase may be equal to the number of predicted roulette outcomes multiplied by a selected wagering amount (e.g., an amount fixed by the game administrator or a player-selected amount greater than an administrator-selected minimum, less than an administrator-selected maximum, or both) less any rake taken by the game administrator. One or more additional conventional roulette wager may be accepted from the player and indication of a predicted characteristic of a roulette outcome for each may be received, which may be reflected by the presence of one or more wagering elements of another designated type located on one or more positions on the wagering area 118.

A plurality of independently randomized roulette outcomes, such as, for example, three or more roulette outcomes, may be generated, which may be reflected by the display of the relevant generated roulette outcome or outcomes in the current primary outcome area 132 and the outcome display area 124. The bonus wager may be resolved by comparing each roulette outcome to the predicted roulette outcome.

A payout on the bonus wager may be paid from the progressive pot to the player when at least one roulette outcome is the same as the predicted roulette outcome, which may be reflected by the transfer of wagering elements to a player, credits added to a meter on a gaming device, or funds credited to a player account and the accompanying decreasing of the amount displayed in the pot tracking area 128. When there is no match between the predicted roulette outcome or outcomes and the three generated roulette outcomes, the amount of the bonus wager originally allocated to the progressive pot may remain in the progressive pot, which may be reflected by maintaining the amount displayed in the pot tracking area 128.

Payouts may be paid on any other roulette wagers when a characteristic of the randomly generated number and associated color is the same as the predicted characteristics associated with the additional wagers, which may be reflected by the transfer of wagering elements to a player, credits added to a meter on a gaming device, or funds credited to a player account. The amounts of any additional wagers may be collected for the game administrator when the characteristic of the relevant one of the generated roulette outcomes is different from the predicted characteristic associated with the other wagers, which may be reflected by the transfer of chips to a dealer or of funds to a house account.

In some embodiments, the wagering games described herein may be played against a game administrator (i.e., against “the house” such that the game is “house-banked”). Such implementations may involve the game administrator (e.g., a casino or other gaming establishment) accepting (e.g., via a croupier or other agent of the administrator) wagers of real-world monetary value, distributing payouts of real-world monetary value on winning wagers to players, and collecting real-world monetary value of lost wagers. Such “house-banked” embodiments may be implemented, for example, in the form of a live table game, in a virtual table game, in an electronic game, or in a networked (e.g., Internet) game configuration.

In other embodiments, the wagering games, or at least one wager associated with the wagering games, may involve a player in a casino or other gaming establishment acting as banker, accepting wagers having real-world monetary value, issuing payouts having real-world monetary value, and collecting real-world monetary value of lost wagers (i.e., be “player banked”). In some embodiments where at least one wager is player-banked, the game administrator may collect a player entrance fee, or a rake on each player-banked wager accepted from the participating players, including the banker.

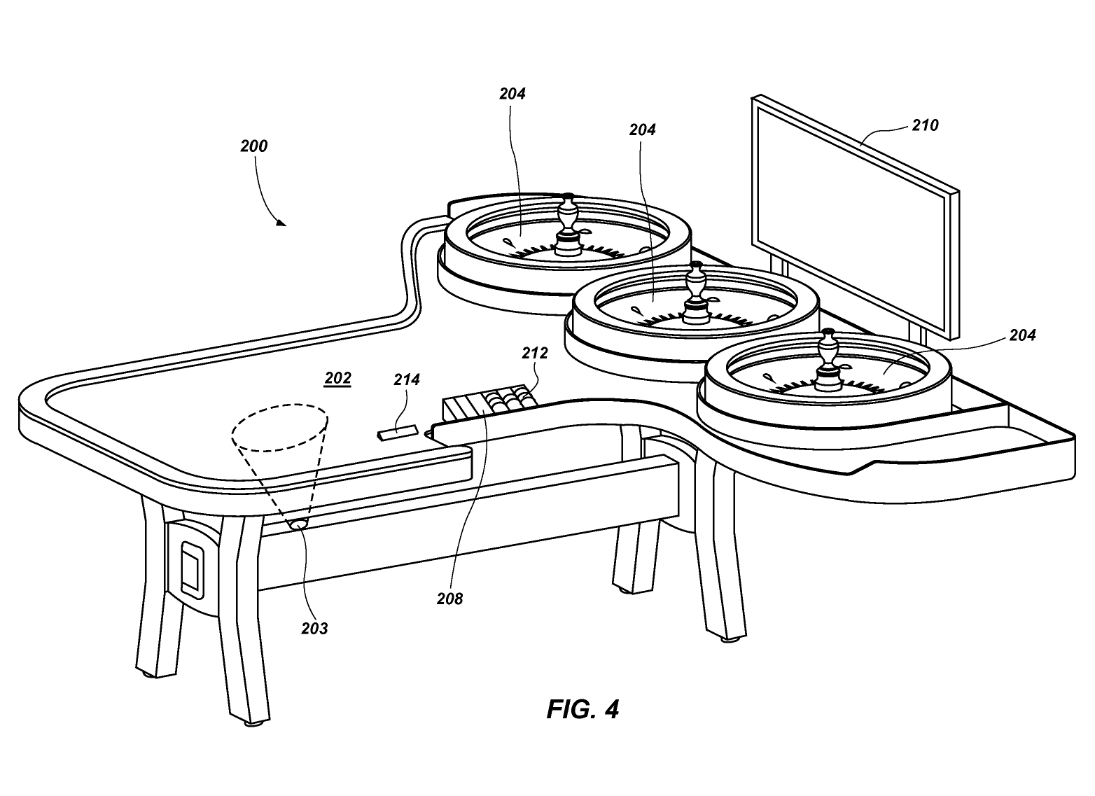

FIG. 4 is a perspective view of an embodiment of a gaming table 200 for implementing wagering games in accordance with this disclosure. The gaming table 200 may be a physical article of furniture around which participants in the wagering game may stand or sit and on which the physical objects used for administering and otherwise participating in the wagering game may be supported, positioned, moved, transferred, and otherwise manipulated. For example, the gaming table 200 may include a gaming surface 202 on which the physical objects used in administering the wagering game may be located. The gaming surface 202 may be, for example, a felt fabric covering a hard surface of the table 200, and a design, conventionally referred to as a “layout,” specific to the game being administered may be physically printed on the gaming surface 202. As another example, the gaming surface 202 may be a surface of a transparent or translucent material (e.g., glass or plexiglass) onto which a projector 203, which may be located, for example, above or below the gaming surface 202, may illuminate a layout specific to the wagering game being administered. In such an example, the specific layout projected onto the gaming surface 202 may be changeable, enabling the gaming table 200 to be used to administer different variations of wagering games within the scope of this disclosure or other wagering games. Additional details of illustrative gaming surfaces and projectors are disclosed in U.S. patent application Ser. No. 13/919,849, filed Jun. 17, 2013, and titled “ELECTRONIC GAMING DISPLAYS, GAMING TABLES INCLUDING ELECTRONIC GAMING DISPLAYS AND RELATED ASSEMBLIES, SYSTEMS AND METHODS,” the disclosure of which is incorporated herein in its entirety by this reference. In either example, the gaming surface 202 may include, for example, designated areas for player positions; areas in which wagering elements of specific types may be stored; areas in which wagers may be accepted; areas in which wagers may be grouped into pots; and areas in which rules, pay tables, and other instructions related to the wagering game may be displayed. As a specific, nonlimiting example, the gaming surface 202 may be configured as shown in FIGS. 2 and 3.

In some embodiments, the gaming table 200 may include a display 210 separate from the gaming surface 202. The display 210 may be configured to face players, prospective players, and spectators and may display, for example, rules, paytables, real-time game status, such as wagers accepted and cards dealt, historical game information, such as amounts won, amounts wagered, percentage of hands won, and notable hands achieved, and other instructions and information related to the wagering game. The display 210 may be a physically fixed display, such as a poster, in some embodiments. In other embodiments, the display 210 may change automatically in response to a stimulus (e.g., may be an electronic video monitor).

The gaming table 200 may include particular machines and apparatuses configured to facilitate the administration of the wagering game. For example, the gaming table 200 may include one or more physical roulette wheels 204. More specifically, the gaming table 200 may include three separate roulette wheels 204, which may generate independently randomized roulette outcomes. The roulette wheels 204 may include, for example, a spinning, recessed surface and a series of numbered and colored pockets into which an outcome identifier (e.g., a ball) may come to rest. The outcome identifiers may be manually introduced into the roulette wheels 204 by a croupier or may be automatically introduced into the roulette wheels 204 by identifier introduction mechanisms. The roulette wheels 204 may simply be supported on the gaming surface 202 in some embodiments. In other embodiments, the roulette wheels 204 may be mounted into the gaming table 202 such that the roulette wheels 204 are not manually removable from the gaming table 202 without the use of tools.

In some embodiments, information related to the wagering game, such as, for example, a menu of game options, the game selected, the number of roulette outcomes to be generated, which outcomes relate to which wagers, acceptable amounts for wagers (e.g., maximums and minimums), wagers accepted for each player, winning and losing wagers, pay tables, and payout amounts may be displayed on the electronic display 210 described previously.

The gaming table 200 may include one or more chip racks 208 configured to facilitate accepting wagers, transferring lost wagers to the house, and exchanging monetary value for wagering elements 212 (e.g., chips). For example, the chip rack 208 may include a series of token support rows, each of which may support tokens of a different type (e.g., color and denomination). In some embodiments, the chip rack 208 may be configured to automatically present a selected number of chips using a chip-cutting-and-delivery mechanism. Additional details of an illustrative chip rack 208 and chip-cutting-and-delivery mechanism are found in U.S. Pat. No. 7,934,980, issued May 3, 2011, to Blaha et al., the disclosure of which is incorporated herein in its entirety by this reference. In some embodiments, the gaming table 200 may include a drop box 214 for money that is accepted in exchange for wagering elements 212. The drop box 214 may be, for example, a secure container (e.g., a safe or lockbox) having a one-way opening into which money may be inserted and a secure, lockable opening from which money may be retrieved. Such drop boxes 214 are known in the art, and may be incorporated directly into the gaming table 200 and may, in some embodiments, have a removable container for the retrieval of money in a separate, secure location.

When administering a wagering game in accordance with embodiments of this disclosure, a croupier may receive money (e.g., cash) from a player in exchange for wagering elements 212. The croupier may deposit the money in the drop box 214 and transfer physical wagering elements 212 to the player. The croupier may accept one or more initial wagers (e.g., antes and other wagers) from the player, which may be reflected by the croupier permitting the player to place one or more wagering elements 212 or other wagering tokens (e.g., cash) within designated areas on the gaming surface 202 associated with the various wagers of the wagering game. Once all wagers have been accepted, outcome identifiers may be introduced into the roulette wheels 204 and permitted to come to rest on three individually randomized roulette outcomes.

Finally, the croupier may resolve the wagers, award payouts to the players, which may be accomplished by giving wagering elements 212 from the chip rack 208 to the players, resetting progressive wagers, which may be accomplished by transferring wagering elements designated for placing the progressive wagers to players or transferring them to the chip rack 208, and transferring losing, nonprogressive wagers to the house, which may be accomplished by moving wagering elements 212 from the surface 202 to the chip rack 208.

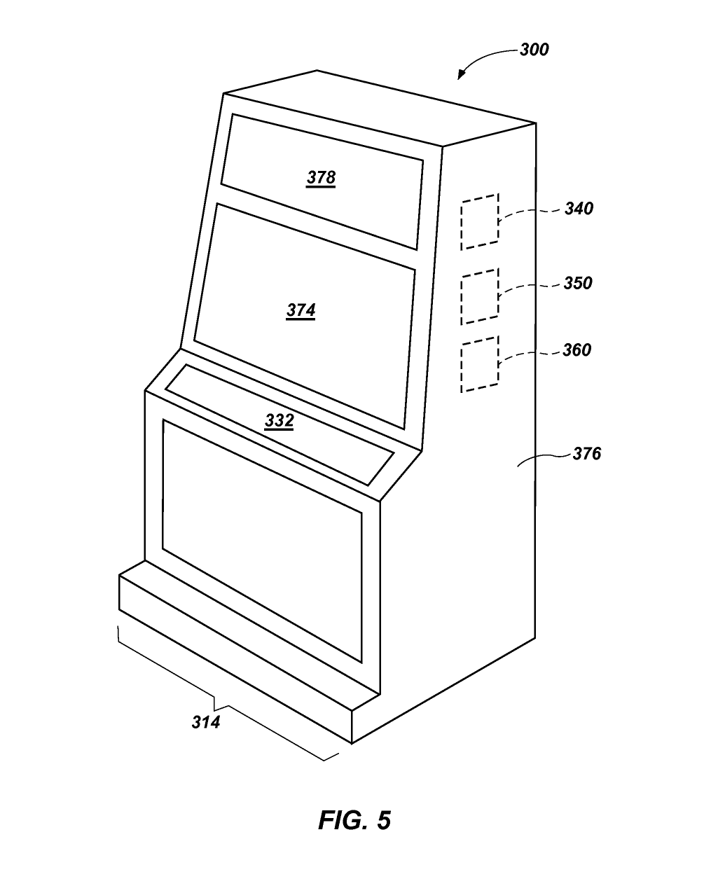

FIG. 5 is a perspective view of an individual electronic gaming device 300 (e.g., an electronic gaming machine (EGM)) configured for implementing wagering games according to this disclosure. The individual electronic gaming device 300 may include an individual player position 314 including a player input area 332 configured to enable a player to interact with the individual electronic gaming device 300 through various input devices (e.g., buttons, levers, touchscreens). The individual electronic gaming device 300 may include a gaming screen 374 configured to display indicia for interacting with the individual electronic gaming device 300, such as through processing one or more programs stored in memory 340 to implement the rules of game play at the individual electronic gaming device 300. Accordingly, game play may be accommodated without involving physical roulette wheels, chips or other wagering elements, and live personnel. The action may instead be simulated by a control processor 350 operably coupled to the memory 340 and interacting with and controlling the individual electronic gaming device 300.

Although the individual electronic gaming device 300 displayed in FIG. 5 has an outline of a traditional gaming cabinet, the individual electronic gaming device 300 may be implemented in other ways, such as, for example, client software downloaded to a portable device, such as a smart phone, tablet, or laptop computer. The individual electronic gaming device 300 may also be a non-portable personal computer (e.g., a desktop or all-in-one computer) or other computing device. In some embodiments, client software is not downloaded but is native to the device or is otherwise delivered with the device when distributed.

A communication device 360 may be included and operably coupled to the processor 350 such that information related to operation of the individual electronic gaming device 300, information related to the game play, or combinations thereof may be communicated between the individual electronic gaming device 300 and other devices, such as a server, through a suitable communication medium, such as, for example, wired networks, Wi-Fi networks, and cellular communication networks.

The gaming screen 374 may be carried by a generally vertically extending cabinet 376 of the individual electronic gaming device 300. The individual electronic gaming device 300 may further include banners to communicate rules of game play and the like, such as along a top portion 378 of the cabinet 376 of the individual electronic gaming device 300. The individual electronic gaming device 300 may further include additional decorative lights, and speakers for transmitting and optionally receiving sounds during game play. Further detail of an example of an individual electronic gaming device 300 (as well as other embodiments of tables and devices) is disclosed in U.S. patent application Ser. No. 13/963,165, filed Aug. 9, 2013, and titled “METHODS AND SYSTEMS FOR ELECTRONIC GAMING,” the disclosure of which is incorporated herein in its entirety by this reference.

Some embodiments may be implemented at locations including a plurality of player stations. Such player stations may include an electronic display screen for display of game information (e.g., cards, wagers, and game instructions) and for accepting wagers and facilitating credit balance adjustments. Such player stations may, optionally, be integrated in a table format, may be distributed throughout a casino or other gaming site, or may include both grouped and distributed player stations.

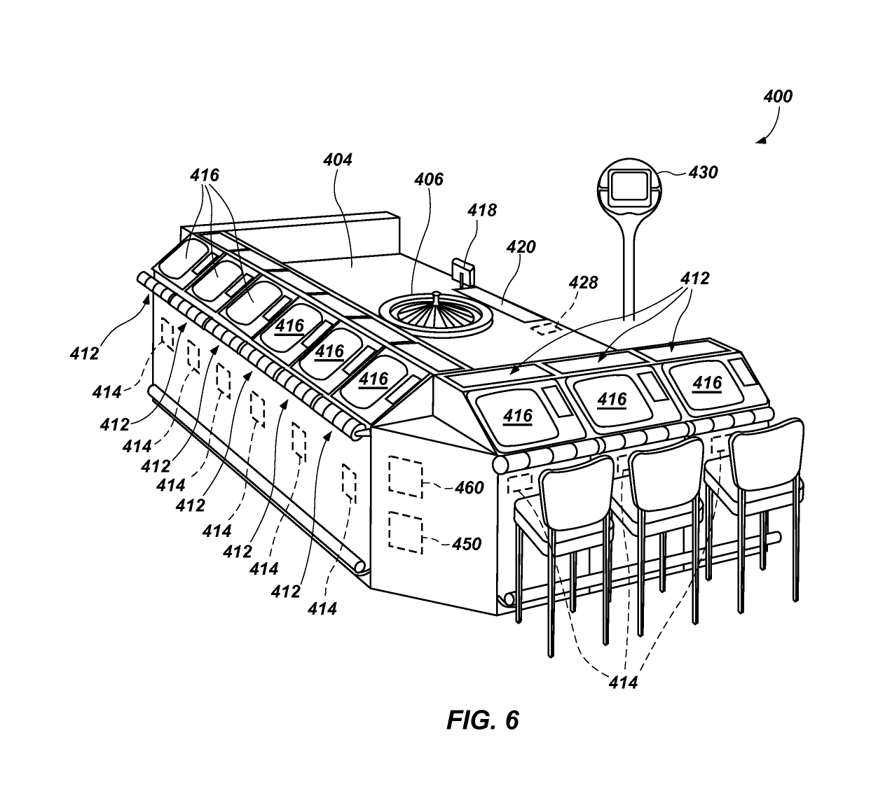

FIG. 6 is a perspective view of an illustrative table 400 configured for implementation of embodiments of wagering games according to the present disclosure. The table 400 may include a playing surface 404, which may be, for example, a felt surface or an electronic display with a roulette wheel 406 mounted into the surface 404. The playing surface 404 may include printed graphics or other information useful to the players or croupier. Chips or other currency may be received on the playing surface 404 to accept wagers. In addition, wagers may be accepted by accepting an electronic authorization to allocate player funds or credits to a wager (e.g., credit wagering) using, for example, player interfaces 416 or the playing surface 404.

When an electronic display is provided (e.g., as the playing surface 404 or as a separate display 430), the display may include a touchscreen and may be used for display of, and in some embodiments, interaction with, information regarding the wagering game (e.g., wagers accepted, historical information, current round information, etc., as described previously in connection with FIGS. 2 and 3).

The table 400 may include a plurality of player stations 412. Each player station 412 may include a separate player interface 416, which may be used for accepting wagers and displaying game information (e.g., game instructions, input options, wager information including virtual chips, game outcomes, etc.). The player interface 416 may include, for example, a display screen in the form of a touchscreen, which may be at least substantially flush with, or raised up from, the playing surface 404 in some embodiments. Each player interface 416 may be coupled respectively to its own local game processor 414 (shown in dashed lines), although, in some embodiments, a central game processor 428 (shown in dashed lines) may be employed and may communicate directly with player interfaces 416. In some embodiments, a combination of individual local game processors 414 and the central game processor 428 may be employed. Each of the processors 414 and 428 may be operably coupled to memory including one or more programs related to the rules of game play at the table 400.

A communication device 460 and a nontransitory memory 450 may be included and may be operably coupled to one or more of the local game processors 414, the central game processor 428, or combinations thereof, such that information related to operation of the table 400, information related to the game play, or combinations thereof may be communicated between the table 400 and other devices through a suitable communication medium, such as, for example, wired networks, Wi-Fi networks, and cellular communication networks.

The table 400 may further include additional features, such as a croupier chip tray 420, which may be used by the croupier to cash players in and out of the wagering game, whereas wagers and balance adjustments during game play may be performed using virtual chips. For embodiments using physical roulette wheels 406, the table 400 may further include a spinning, physical roulette wheel 406 that may be configured to receive a ball or other indicator, which may come to rest in individual, separate sections with numbers and colors therein to generate a random outcome for a round of roulette. For embodiments using virtual roulette outcome generation, the outcome may be displayed at the individual player interfaces 416, on a common display 430, or both.

The table 400 may further include a croupier interface 418, which, like the player interfaces 416, may include touchscreen controls enabling the croupier to control or otherwise interact with administration of the wagering game. The table 400 may further include an upright common display 430 configured to display images that depict game information, such as, for example, the information described previously in connection with FIGS. 2 and 3 and a wide variety of other information considered useful to the players, including a video display of each roulette outcome, in real-time. A camera may be trained on the wheel 406 and video recordings of each wheel spin may be captured and displayed on the display 430. The upright display 430 may be double sided to provide such information to players as well as to the casino pit.

Further detail of an example of a table and player displays is disclosed in U.S. Pat. No. 6,659,866, issued Dec. 9, 2003, for “AUTOMATIC TABLE GAME,” the disclosure of which is incorporated herein in its entirety by this reference. Although an embodiment is described showing individual discrete player stations, in some embodiments, the entire playing surface 404 may be an electronic display that is logically partitioned to permit game play from a plurality of players for receiving inputs from, and displaying game information to, the players, the croupier, or both.

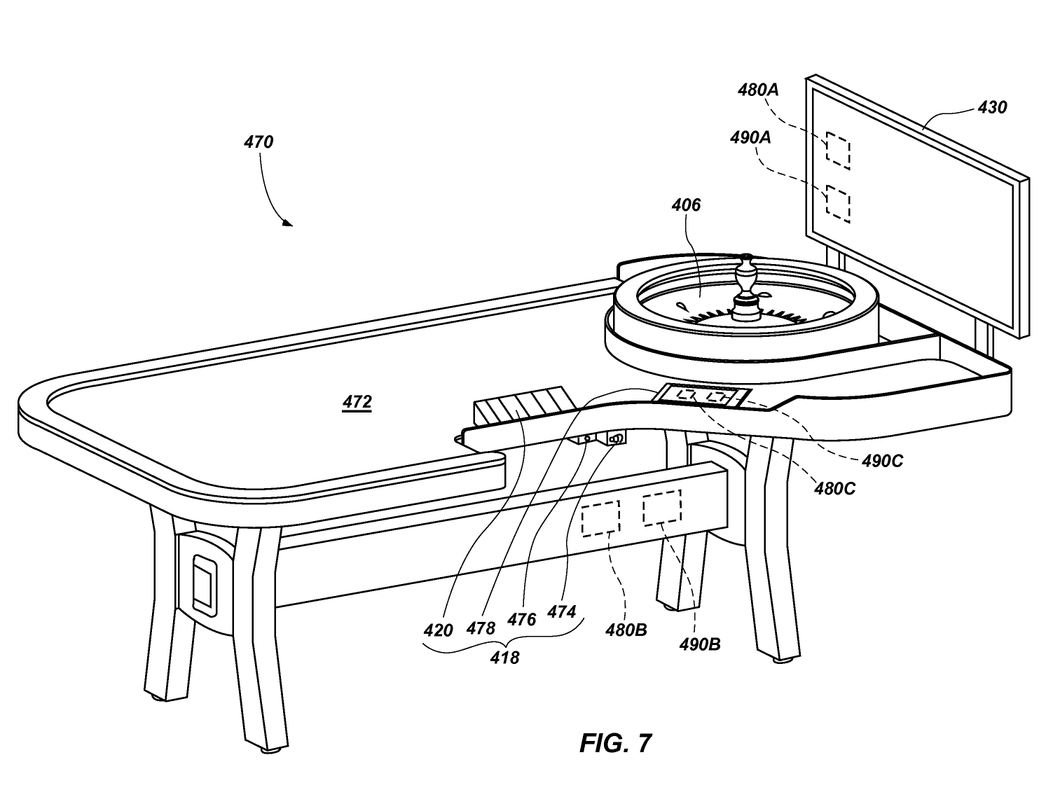

FIG. 7 is a perspective side view of another embodiment of a table 470 configured for implementation of embodiments of wagering games in accordance with the present disclosure. The table 470 may include a playing surface 472, which may be, for example, a felt layout or an electronic display similar to the playing surface 112 described previously in connection with FIG. 2. The table 470 may further include a physical roulette wheel 406 proximate to, and in some embodiments supported by, the playing surface 472. The table 470 may include a video display 430 configured to display game information, such as, for example, the information described previously in connection with FIGS. 2 and 3 and any other information considered useful to the players, including acceptance of wagers, game outcomes, wager outcomes, payout multipliers, historical game outcome data, and other information, in real-time.

The table 470 may include features for at least partially automating administration of a wagering game using the table 470. For example, the table 470 may include a croupier interface 418, which may enable an in-person administrator (e.g., a croupier) to initiate automated administration of certain actions and to personally perform other actions associated with administering a wagering game. The croupier interface 418 may include, for example, a croupier chip tray 420, which may be configured to support house chips, to which lost wagers may be added, and from which payouts may be paid. The croupier interface 418 may include a player authenticator 474 (e.g., a magnetic strip reader for cards carrying player information encoded on a magnetic strip), which may be configured to verify the identity of a player and grant access to a player account for the purpose of paying payouts, granting complimentary items and services (i.e., “comps”) to players, redeeming chips for monetary value and vice versa, or performing other actions requiring a player's verified identity. The croupier interface 418 may include game initiation and control devices, such as, for example, buttons 476 and touchscreens 478, which may be configured to initiate random game events (e.g., electronic generation of roulette outcomes), verify authorization for large payout awards, enter wagering or outcome information for the purpose of game tracking, activating and deactivating automated portions of game administration (e.g., turning the table 470 and associated components on and off), and performing other actions to initiate and control the automatic administration of the wagering game.

The table 470 may include at least one processor 480, which may be associated, for example, with the video display 430 (e.g., processor 480A), the table 470 itself (e.g., processor 480B), or the touchscreen 478 (e.g., processor 480C) of the croupier interface 418. The one or more processors 480 may access game rules and game assets (e.g., videos, images, and text) stored in at least one nontransitory memory 490, which may similarly be associated, for example, with the video display 430 (e.g., memory 490A), the table 470 itself (e.g., memory 490B), or the touchscreen 478 (e.g., memory 490C) of the croupier interface 418. For example, the one or more processors 480 may randomly generate one or more roulette outcomes in a given round of play, interpret a random game outcome, declare winning wager conditions, and control display of information on the video display 430.

At least some of the actions performed in connection with administering a wagering game using the table 470 may be accomplished by an in-person croupier. For example, wagers may be accepted by a croupier permitting a player to place a chip in a designated area on the playing surface 472, one of the roulette outcomes in a given round of play may be randomly generated by the croupier introducing an indicator (e.g., a ball) into the spinning physical roulette wheel 406 and permitting it to come to rest on a space defined by the physical roulette wheel 406, and payouts may be paid by the croupier giving chips from a croupier chip tray 420 to a player, for example, by placing them on the playing surface 472 proximate the player. Other actions performed in connection with administering a wagering game using the table 470 may be accomplished automatically by one or more processors 480, which may occur in response to croupier input or may occur automatically in response to other game events. For example, one or more processors 480 may randomly generate one or more roulette outcomes (e.g., two roulette outcomes) in response to a croupier indicating that wagering is closed, may automatically generate one or more roulette outcomes (e.g., two roulette outcomes) randomly at the close of wagering or at the beginning of a new round of play (e.g., after a timer has expired), may automatically interpret a random game outcome (e.g., using sensors in the physical roulette wheel 406 or using imaging sensors configured to capture information from the physical roulette wheel 406), and may apply game rules and display all winning game conditions associated with the random game outcomes on the video display 430.

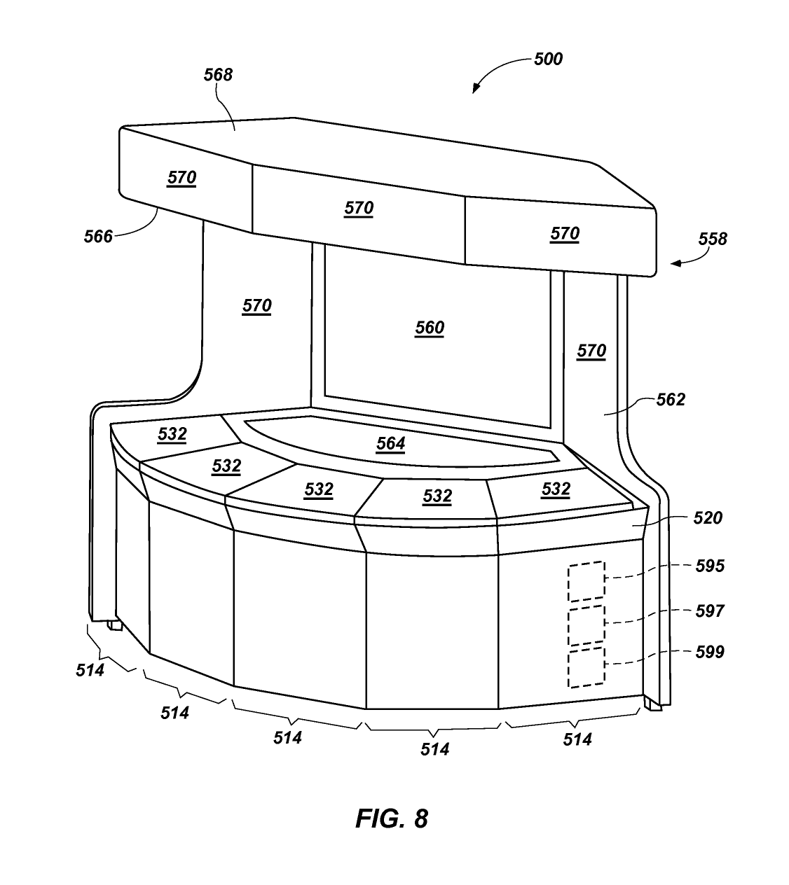

FIG. 8 is a perspective view of another embodiment of a suitable table 500 configured for implementing wagering games according to the present disclosure utilizing a virtual croupier. The table 500 may include player positions 514 arranged in a bank about an arcuate edge 520 of a video device 558 that may comprise a roulette outcome screen 564 and a croupier screen 560. The croupier screen 560 may display a video simulation of the croupier (i.e., a virtual croupier) for interacting with the video device 558, such as through processing one or more stored programs stored in memory 595 to implement the rules of game play at the video device 558. The croupier screen 560 may be carried by a generally vertically extending cabinet 562 of the video device 558. The roulette outcome screen 564 may be configured to display generated roulette outcomes (e.g., by displaying virtual roulette wheels or simply images and text).

Each of the player positions 514 may include a player interface area 532 configured for wagering and game play interactions with the video device 558 and virtual croupier. Accordingly, game play may be accommodated without involving physical roulette wheels, wagering chips, and live personnel. The action may instead be simulated by a control processor 597 interacting with and controlling the video device 558. The control processor 597 may be programmed, by known techniques, to implement the rules of game play at the video device 558. As such, the control processor 597 may interact and communicate with display/input interfaces and data entry inputs for each player interface area 532 of the video device 558. Other embodiments of tables and gaming devices may include a control processor that may be similarly adapted to the specific configuration of its associated device.

A communication device 599 may be included and operably coupled to the control processor 597 such that information related to operation of the table 500, information related to the game play, or combinations thereof may be communicated between the table 500 and other devices, such as a central server, through a suitable communication medium, such as, for example, wired networks, Wi-Fi networks, and cellular communication networks.

The video device 558 may further include banners communicating rules of play and the like, which may be located along one or more walls 570 of the cabinet 562. The video device 558 may further include additional decorative lights and speakers, which may be located on an underside surface 566, for example, of a generally horizontally extending top 568 of the cabinet 562 of the video device 558 generally extending toward the player positions 514.

Further detail of an example of a table and player displays is disclosed in U.S. Pat. No. 8,272,958, issued Sep. 25, 2012, and titled “AUTOMATED MULTIPLAYER GAME TABLE WITH UNIQUE IMAGE FEED OF DEALER,” the disclosure of which is incorporated herein in its entirety by this reference. Although an embodiment is described showing individual discrete player stations, in some embodiments, the entire playing surface (e.g., player interface areas 532, card screen 564, etc.) may be a unitary electronic display that is logically partitioned to permit game play from a plurality of players for receiving inputs from, and displaying game information to, the players, the croupier, or both.

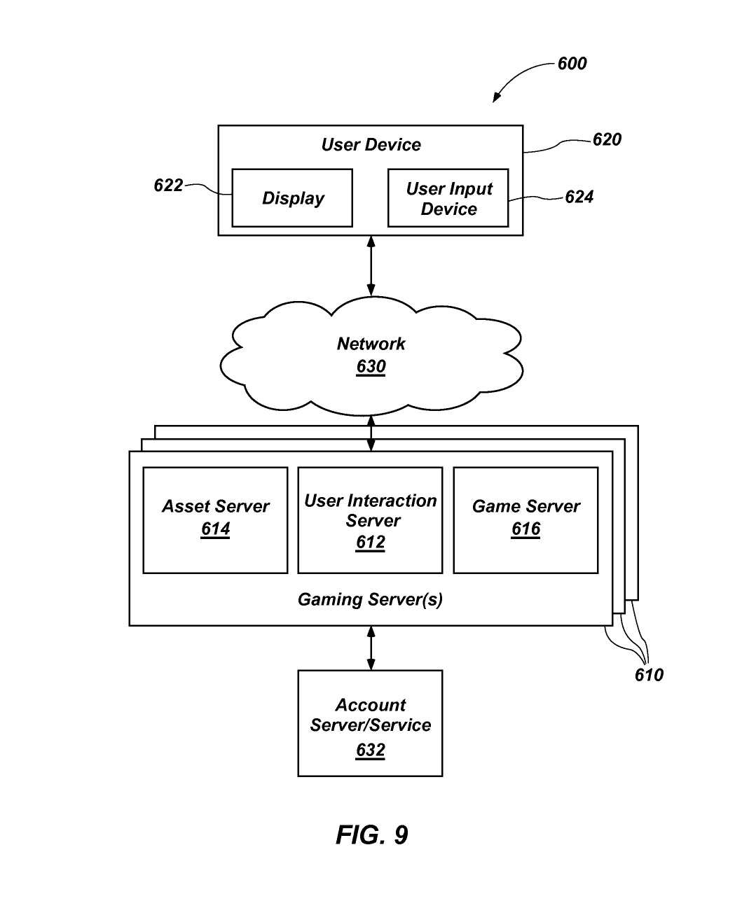

In some embodiments, wagering games in accordance with this disclosure may be administered using a gaming system employing a client-server architecture (e.g., over the Internet, a local area network, etc.). FIG. 9 is a schematic block diagram of an illustrative gaming system 600 for implementing wagering games according to this disclosure. The gaming system 600 may enable end users to remotely access game content. Such game content may include, without limitation, various types of wagering games such as card games, dice games, big wheel games, roulette, scratch off games (“scratchers”), and any other wagering game where the game outcome is determined, in whole or in part, by one or more random events. This includes, but is not limited to, Class II and Class III games as defined under 25 U.S.C. §2701 et seq. (“Indian Gaming Regulatory Act”). Such games may include banked and/or non-banked games.

The wagering games supported by the gaming system 600 may be operated with real currency or with virtual credits or other virtual (e.g., electronic) value indicia. For example, the real currency option may be used with traditional casino and lottery-type wagering games in which money or other items of value are wagered and may be cashed out at the end of a game session. The virtual credits option may be used with wagering games in which credits (or other symbols) may be issued to a player to be used for the wagers. A player may be credited with credits in any way allowed, including, but not limited to, a player purchasing credits; being awarded credits as part of a contest or a win event in this or another game (including non-wagering games); being awarded credits as a reward for use of a product, casino, or other enterprise, time played in one session, or games played; or may be as simple as being awarded virtual credits upon logging in at a particular time or with a particular frequency, etc. Although credits may be won or lost, the ability of the player to cash out credits may be controlled or prevented. In one example, credits acquired (e.g., purchased or awarded) for use in a play-for-fun game may be limited to non-monetary redemption items, awards, or credits usable in the future or for another game or gaming session. The same credit redemption restrictions may be applied to some or all of credits won in a wagering game as well.

An additional variation includes web-based sites having both play-for-fun and wagering games, including issuance of free (non-monetary) credits usable to play the play-for-fun games. This feature may attract players to the site and to the games before they engage in wagering. In some embodiments, a limited number of free or promotional credits may be issued to entice players to play the games. Another method of issuing credits includes issuing free credits in exchange for identifying friends who may want to play. In another embodiment, additional credits may be issued after a period of time has elapsed to encourage the player to resume playing the game. The gaming system 600 may enable players to buy additional game credits to allow the player to resume play. Objects of value may be awarded to play-for-fun players, which may or may not be in a direct exchange for credits. For example, a prize may be awarded or won for a highest scoring play-for-fun player during a defined time interval. All variations of credit redemption are contemplated, as desired by game designers and game hosts (the person or entity controlling the hosting systems).

The gaming system 600 may include a gaming platform to establish a portal for an end user to access a wagering game hosted by one or more gaming servers 610 over a network 630. In some embodiments, games are accessed through a user interaction service 612. The gaming system 600 enables players to interact with a user device 620 through a user input device 624 and a display 622 and to communicate with one or more gaming servers 610 using a network 630 (e.g., the Internet). Typically, the user device is remote from the gaming server 610 and the network is the word-wide web (i.e., the Internet).

In some embodiments, the gaming servers 610 may be configured as a single server to administer wagering games in combination with the user device 620. In other embodiments, the gaming servers 610 may be configured as separate servers for performing separate, dedicated functions associated with administering wagering games. Accordingly, the following description also discusses “services” with the understanding that the various services may be performed by different servers or combinations of servers in different embodiments. As shown in FIG. 9, the gaming servers 610 may include a user interaction service 612, a game service 616, and an asset service 614. In some embodiments, one or more of the gaming servers 610 may communicate with an account server 632 performing an account service 632. As explained more fully below, for some wagering type games, the account service 632 may be separate and operated by a different entity than the gaming servers 610; however, in some embodiments the account service 632 may also be operated one or more of the gaming servers 610.

The user device 620 may communicate with the user interaction service 612 through the network 630. The user interaction service 612 may communicate with the game service 616 and provide game information to the user device 620. In some embodiments, the game service 616 may also include a game engine. The game engine may, for example, access, interpret, and apply game rules. In some embodiments, a single user device 620 communicates with a game provided by the game service 616, while other embodiments may include a plurality of user devices 620 configured to communicate and provide end users with access to the same game provided by the game service 616. In addition, a plurality of end users may be permitted to access a single user interaction service 612, or a plurality of user interaction services 612, to access the game service 616.The user interaction service 612 may enable a user to create and access a user account and interact with game service 616. The user interaction service 612 may enable users to initiate new games, join existing games, and interface with games being played by the user.

The user interaction service 612 may also provide a client for execution on the user device 620 for accessing the gaming servers 610. The client provided by the gaming servers 610 for execution on the user device 620 may be any of a variety of implementations depending on the user device 620 and method of communication with the gaming servers 610. In one embodiment, the user device 620 may connect to the gaming servers 610 using a web browser, and the client may execute within a browser window or frame of the web browser. In another embodiment, the client may be a stand-alone executable on the user device 620.

For example, the client may comprise a relatively small amount of script (e.g., JAVASCRIPT®), also referred to as a “script driver,” including scripting language that controls an interface of the client. The script driver may include simple function calls requesting information from the gaming servers 610. In other words, the script driver stored in the client may merely include calls to functions that are externally defined by, and executed by, the gaming servers 610. As a result, the client may be characterized as a “thin client.” The client may simply send requests to the gaming servers 610 rather than performing logic itself. The client may receive player inputs, and the player inputs may be passed to the gaming servers 610 for processing and executing the wagering game. In some embodiments, this may involve providing specific graphical display information for the display 622 as well as game outcomes.

As another example, the client may comprise an executable file rather than a script. The client may do more local processing than does a script driver, such as calculating where to show what game symbols upon receiving a game outcome from the game service 616 through user interaction service 612. In some embodiments, portions of an asset service 614 may be loaded onto the client and may be used by the client in processing and updating graphical displays. Some form of data protection, such as end-to-end encryption, may be used when data is transported over the network 630. The network 630 may be any network, such as, for example, the Internet or a local area network.

The gaming servers 610 may include an asset service 614, which may host various media assets (e.g., text, audio, video, and image files) to send to the user device 620 for presenting the various wagering games to the end user. In other words, the assets presented to the end user may be stored separately from the user device 620. For example, the user device 620 requests the assets appropriate for the game played by the user; as another example, especially relating to thin clients, just those assets that are needed for a particular display event will be sent by the gaming servers 610, including as few as one asset. The user device 620 may call a function defined at the user interaction service 612 or asset service 614, which may determine which assets are to be delivered to the user device 620 as well as how the assets are to be presented by the user device 620 to the end user. Different assets may correspond to the various user devices 620 and their clients that may have access to the game service 616 and to different variations of wagering games.

The gaming servers 610 may include the game service 616, which may be programmed to administer wagering games and determine game play outcomes to provide to the user interaction service 612 for transmission to the user device 620. For example, the game service 616 may include game rules for one or more wagering games, such that the game service 616 controls some or all of the game flow for a selected wagering game as well as the determined game outcomes. The game service 616 may include pay tables and other game logic. The game service 616 may perform random number generation for determining random game elements of the wagering game. In one embodiment, the game service 616 may be separated from the user interaction service 612 by a firewall or other method of preventing unauthorized access to the game service 612 by the general members of the network 630.

The user device 620 may present a gaming interface to the player and communicate the user interaction from the user input device 624 to the gaming servers 610. The user device 620 may be any electronic system capable of displaying gaming information, receiving user input, and communicating the user input to the gaming servers 610. For example, the user device 620 may be a desktop computer, a laptop, a tablet computer, a set-top box, a mobile device (e.g., a smartphone), a kiosk, a terminal, or another computing device. As a specific, nonlimiting example, the user device 620 operating the client may be an interactive electronic gaming system 300 (see FIG. 5), as described above. The client may be a specialized application or may be executed within a generalized application capable of interpreting instructions from an interactive gaming system, such as a web browser.

The client may interface with an end user through a web page or an application that runs on a device including, but not limited to, a smartphone, a tablet, or a general computer, or the client may be any other computer program configurable to access the gaming servers 610. The client may be illustrated within a casino webpage (or other interface) indicating that the client is embedded into a webpage, which is supported by a web browser executing on the user device 620.

In some embodiments, components of the gaming system 600 may be operated by different entities. For example, the user device 620 may be operated by a third party, such as a casino or an individual, that links to the gaming servers 610, which may be operated, for example, by a wagering game service provider. Therefore, in some embodiments, the user device 620 and client may be operated by a different administrator than the operator of the game service 616. In other words, the user device 620 may be part of a third-party system that does not administer or otherwise control the gaming servers 610 or game service 616. In other embodiments, the user interaction service 612 and asset service 614 may be operated by a third-party system. For example, a gaming entity (e.g., a casino) may operate the user interaction service 612, user device 620, or combination thereof to provide its customers access to game content managed by a different entity that may control the game service 616, amongst other functionality. In still other embodiments, all functions may be operated by the same administrator. For example, a gaming entity (e.g., a casino) may elect to perform each of these functions in-house, such as providing access to the user device 620, delivering the actual game content, and administering the gaming system 600.

The gaming servers 610 may communicate with one or more external account servers 632 (also referred to herein as an account service 632), optionally through another firewall. For example, the gaming servers 610 may not directly accept wagers or issue payouts. That is, the gaming servers 610 may facilitate online casino gaming but may not be part of a self-contained online casino itself. Another entity (e.g., a casino or any account holder or financial system of record) may operate and maintain its external account service 632 to accept bets and make payout distributions. The gaming servers 610 may communicate with the account service 632 to verify the existence of funds for wagering and to instruct the account service 632 to execute debits and credits. As another example, the gaming servers 610 may directly accept bets and make payout distributions, such as in the case where an administrator of the gaming servers 610 operates as a casino.

Additional features may be supported by the gaming servers 610, such as hacking and cheating detection, data storage and archival, metrics generation, messages generation, output formatting for different end user devices, as well as other features and operations. For example, the gaming servers 610 may include additional features and configurations as described in U.S. patent application Ser. No. 13/353,194, filed Jan. 18, 2012, and U.S. patent application Ser. No. 13/609,031, filed Sep. 10, 2012, both applications titled “NETWORK GAMING ARCHITECTURE, GAMING SYSTEMS, AND RELATED METHODS,” the disclosure of each of which is incorporated herein in its entirety by this reference.

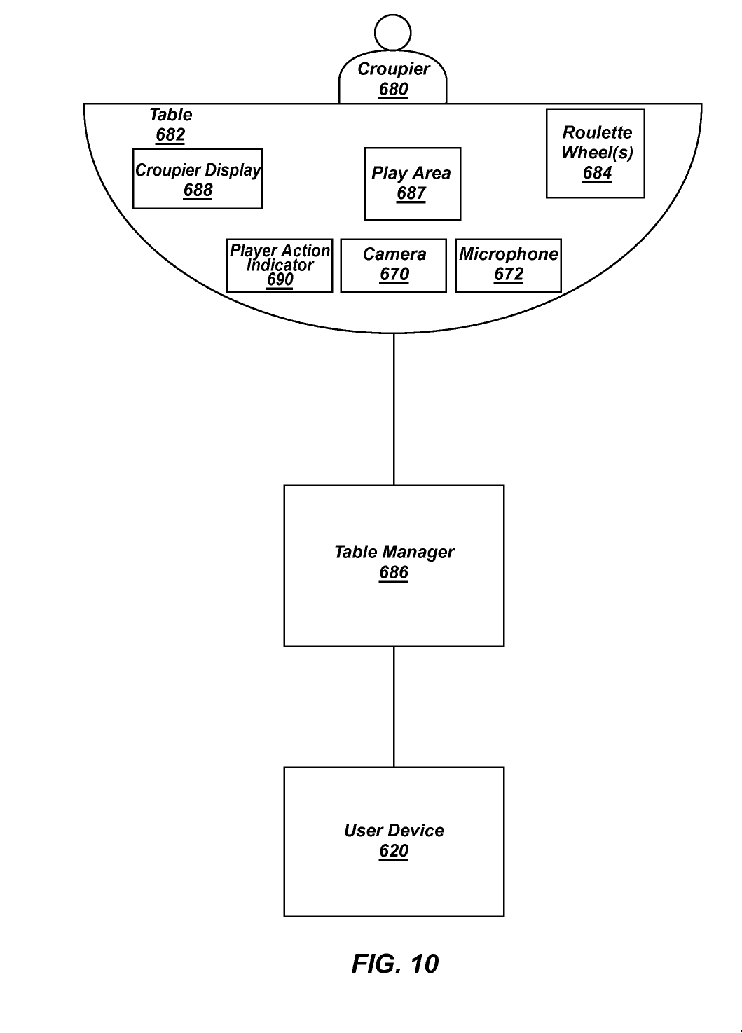

FIG. 10 is a schematic block diagram of a table 682 for implementing wagering games including a live croupier feed. Features of the gaming system 600 described above in connection with FIG. 9 may be utilized in connection with this embodiment, except as further described. Rather than roulette outcomes being generated by a computerized random processes, a physical outcome identifier or identifiers (e.g., balls or marbles) may be introduced into one or more corresponding physical roulette wheels 684 by a live croupier 680 at a table 682. A table manager 686 may assist the croupier 680 in facilitating play of the game by transmitting a video feed of the croupier's actions to the user device 620 and transmitting player elections to the croupier 680. As described above, the table manager 686 may act as or communicate with a gaming system 600 (see FIG. 9) (e.g., acting as the gaming system 600 (see FIG. 9)) itself or as an intermediate client interposed between and operationally connected to the user device 620 and the gaming system 600 (see FIG. 9)) to provide gaming at the table 682 to users of the gaming system 600 (see FIG. 9). Thus, the table manager 686 may communicate with the user device 620 through a network 630 (see FIG. 9), and may be a part of a larger online casino, or may be operated as a separate system facilitating game play. In various embodiments, each table 682 may be managed by an individual table manager 686 constituting a gaming device, which may receive and process information relating to that table. For simplicity of description, these functions are described as being performed by the table manager 686, though certain functions may be performed by an intermediary gaming system 600 (see FIG. 9), such as the one shown and described in connection with FIG. 9. In some embodiments, the gaming system 600 (see FIG. 9) may match remotely located players to tables 682 and facilitate transfer of information between user devices 620 and tables 682, such as wagering amounts and player option elections, without managing gameplay at individual tables. In other embodiments, functions of the table manager 686 may be incorporated into a gaming system 600 (see FIG. 9).

The table 682 includes a camera 670 and optionally a microphone 672 to capture video and audio feeds relating to the table 682. The camera 670 may be trained on the croupier 680, play area 687, and roulette wheel or wheels 684. As the game is administered by the croupier 680, the video feed captured by the camera 670 may be shown to the player using the user device 620, and any audio captured by the microphone 672 may be played to the player using the user device 620. In some embodiments, the user device 620 may also include a camera, microphone, or both, which may also capture feeds to be shared with the croupier 680 and other players. In some embodiments, the camera 670 may be trained to capture images of the roulette outcomes, chips, and chip stacks on the surface of the gaming table. Known image extraction techniques may be used to obtain roulette outcome from the images of the roulette wheel or wheels 684. An example of suitable image extraction software is disclosed in U.S. Pat. No. 7,901,285, issued Mar. 8, 2011, to Tran et al., the disclosure of which is incorporated in this disclosure in its entirety by this reference.

Roulette outcome data in some embodiments may be used by the table manager 686 to determine game outcome. The data extracted from the camera 670 may be used to confirm roulette outcome data obtained from the roulette wheel or wheels 684 (e.g., using sensors) and for general security monitoring purposes, such as detecting player or croupier outcome or wager manipulation, for example. Examples of roulette outcome data include, for example, number and color information of a roulette outcome and number and color information of each roulette outcome in a set of roulette outcomes (e.g., three roulette outcomes from the same round of play).

The live video feed permits the croupier to use one or more physical roulette wheels and play the game as though the player were at a live casino. In addition, the croupier can prompt a user by announcing a player's election is to be performed. In embodiments where a microphone 672 is included, the croupier 680 can verbally announce action or request an election by a player. In some embodiments, the user device 620 also includes a camera or microphone, which also captures feeds to be shared with the croupier 680 and other players.

The roulette wheel or wheels 684 may be as shown and described previously in connection with FIG. 4. The play area 686 depicts player positions for playing the game, such as shown in FIGS. 2 and 3. As determined by the rules of the game, the player at the user device 620 may be presented options for responding to an event in the game using a client as described with reference to FIG. 8.

Player elections may be transmitted to the table manager 686, which may display player elections to the croupier 680 using a croupier display 688 and player action indicator 690 on the table 682. For example, the croupier display 688 may display information regarding when to close betting, when to introduce an outcome identifier into a physical, spinning roulette wheel 684, or which player position is responsible for the next action.

In some embodiments, the table manager 686 may receive roulette outcome information from each roulette wheel 684. For example, the roulette wheel or wheels 684 may include sensors to detect specific spaces on the roulette wheel and which space an outcome identifier is positioned on. In some embodiments, the table manager 686 may generate roulette outcome information (e.g., alone or in addition to the information received from one or more roulette wheels 684).

The table manager 686 may apply game rules to the roulette outcome information, along with the accepted player decisions, to determine gameplay events and wager results. Alternatively, the wager results may be determined by the croupier 680 and input to the table manager 686, which may be used to confirm automatically determined results by the gaming system.

Roulette outcome data in some embodiments may be used by the table manager 686 to determine game outcome. The data extracted from the camera 670 may be used to confirm the data obtained from the roulette wheel or wheels 684 and for general security monitoring purposes, such as detecting player or croupier outcome or wager manipulation, for example.

The live video feed permits the croupier to physically generate one or more randomized roulette outcomes and play the game as though the player were at a live casino. In addition, the croupier can prompt a user by announcing a player's election is to be performed. In embodiments where a microphone 672 is included, the croupier 680 can verbally announce action or request an election by a player. In some embodiments, the user device 620 also includes a camera or microphone, which also captures feeds to be shared with the croupier 680 and other players.

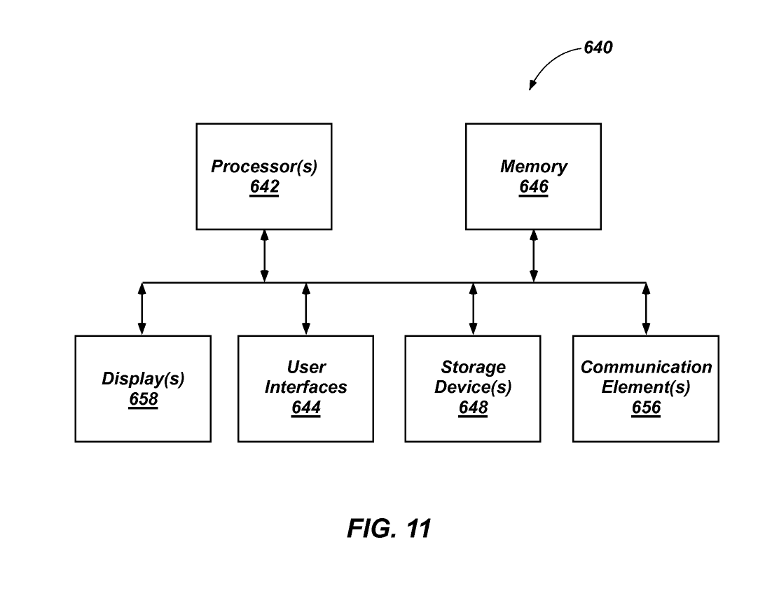

FIG. 11 is a simplified block diagram showing elements of computing devices that may be used in systems and apparatuses of this disclosure. The computing system 640 may be a user-type computer, a file server, a computer server, a notebook computer, a tablet, a handheld device, a mobile device, or other similar computer system for executing software. The computing system 640 may be configured to execute software programs containing computing instructions and may include one or more processors 642, memory 646, one or more displays 658, one or more user interface elements 644, one or more communication elements 656, and one or more storage devices 648 (also referred to herein simply as storage 648).

The processors 642 may be configured to execute a wide variety of operating systems and applications including the computing instructions for administering wagering games of the present disclosure.

The processors 642 may be configured as a general-purpose processor such as a microprocessor, but in the alternative, the general-purpose processor may be any processor, controller, microcontroller, or state machine suitable for carrying out processes of the present disclosure. The processor 642 may also be implemented as a combination of computing devices, such as a combination of a DSP and a microprocessor, a plurality of microprocessors, one or more microprocessors in conjunction with a DSP core, or any other such configuration.

A general-purpose processor may be part of a general-purpose computer. However, when configured to execute instructions (e.g., software code) for carrying out embodiments of the present disclosure the general-purpose computer should be considered a special-purpose computer. Moreover, when configured according to embodiments of the present disclosure, such a special-purpose computer improves the function of a general-purpose computer because, absent the present disclosure, the general-purpose computer would not be able to carry out the processes of the present disclosure. The processes of the present disclosure, when carried out by the special-purpose computer, are processes that a human would not be able to perform in a reasonable amount of time due to the complexities of the data processing, decision making, communication, interactive nature, or combinations thereof for the present disclosure. The present disclosure also provides meaningful limitations in one or more particular technical environments that go beyond an abstract idea. For example, embodiments of the present disclosure provide improvements in the technical field related to the present disclosure.

The memory 646 may be used to hold computing instructions, data, and other information for performing a wide variety of tasks including administering wagering games of the present disclosure. By way of example, and not limitation, the memory 646 may include Synchronous Random Access Memory (SRAM), Dynamic RAM (DRAM), Read-Only Memory (ROM), Flash memory, and the like.

The display 658 may be a wide variety of displays such as, for example, light emitting diode displays, liquid crystal displays, cathode ray tubes, and the like. In addition, the display 658 may be configured with a touch-screen feature for accepting user input as a user interface element 644.

As nonlimiting examples, the user interface elements 644 may include elements such as displays, keyboards, push-buttons, mice, joysticks, haptic devices, microphones, speakers, cameras, and touchscreens.

As nonlimiting examples, the communication elements 656 may be configured for communicating with other devices or communication networks. As nonlimiting examples, the communication elements 656 may include elements for communicating on wired and wireless communication media, such as for example, serial ports, parallel ports, Ethernet connections, universal serial bus (USB) connections, IEEE 1394 (“firewire”) connections, THUNDERBOLT™ connections, BLUETOOTH® wireless networks, ZigBee wireless networks, 802.11 type wireless networks, cellular telephone/data networks, and other suitable communication interfaces and protocols.

The storage 648 may be used for storing relatively large amounts of nonvolatile information for use in the computing system 640 and may be configured as one or more storage devices. By way of example, and not limitation, these storage devices may include computer readable media (CRM). This CRM may include, but is not limited to, magnetic and optical storage devices such as disk drives, magnetic tape, CDs (compact discs), DVDs (digital versatile discs or digital video discs), and semiconductor devices such as RAM, DRAM, ROM, EPROM, Flash memory, and other equivalent storage devices.

A person of ordinary skill in the art will recognize that the computing system 640 may be configured in many different ways with different types of interconnecting buses between the various elements. Moreover, the various elements may be subdivided physically, functionally, or a combination thereof. As one nonlimiting example, the memory 646 may be divided into cache memory, graphics memory, and main memory. Each of these memories may communicate directly or indirectly with the one or more processors 642 on separate buses, partially combined buses, or a common bus.

As a specific, nonlimiting example, various methods and features of the present disclosure may be implemented in a mobile, remote, or mobile and remote environment over one or more of Internet, cellular communication (e.g., Broadband), near-field communication networks and other communication networks referred to collectively herein as an iGaming environment. The iGaming environment may be accessed through social media environments such as FACEBOOK® and the like. DragonPlay Ltd, acquired by Bally Technologies Inc., assignee of the present disclosure, provides an example of a platform to provide games to user devices, such as cellular telephones and other devices utilizing ANDROID®, iPHONE® and FACEBOOK® platforms. Where permitted by jurisdiction, the iGaming environment can include pay-to-play (P2P) gaming where a player, from their device, can make value based wagers and receive value based awards. Where P2P is not permitted, the features can be expressed as entertainment only gaming where players wager virtual credits having no value or risk no wager whatsoever such as playing a promotion game or feature.

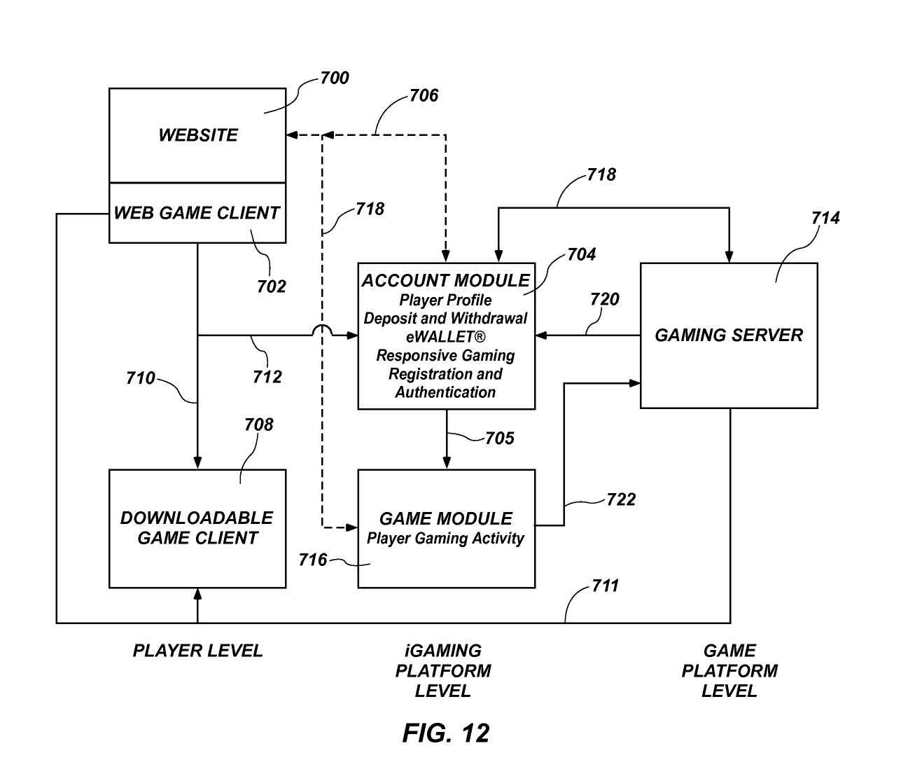

FIG. 12 illustrates an illustrative embodiment of information flows in an iGaming environment. At a player level, the player or user accesses a site hosting the activity such as a website 700. The website 700 may functionally provide a web game client 702. The web game client 702 may be, for example, represented by a game client 708 downloadable at information flow 710, which may process applets transmitted from a gaming server 714 at information flow 711 for rendering and processing game play at a player's remote device. Where the game is a P2P game, the gaming server 714 may process value-based wagers (e.g., money wagers) and randomly generate an outcome for rendition at the player's device. In some embodiments, the web game client 702 may access a local memory store to drive the graphic display at the player's device. In other embodiments, all or a portion of the game graphics may be streamed to the player's device with the web game client 702 enabling player interaction and display of game features and outcomes at the player's device.

The website 700 may access a player-centric, iGaming-platform-level account module 704 at information flow 706 for the player to establish and confirm credentials for play and, where permitted, access an account (e.g., an eWALLET®) for wagering. The account module 704 may include or access data related to the player's profile (e.g., player-centric information desired to be retained and tracked by the host), the player's electronic account, deposit, and withdrawal records, registration and authentication information, such as username and password, name and address information, date of birth, a copy of a government issued identification document, such as a driver's license or passport, and biometric identification criteria, such as fingerprint or facial recognition data, and a responsible gaming module containing information, such as self-imposed or jurisdictionally imposed gaming restraints, such as loss limits, daily limits and duration limits. The account module 704 may also contain and enforce geo-location limits, such as geographic areas where the player may play P2P games, user device IP address confirmation, and the like.

The account module 704 communicates at information flow 705 with a game module 716 to complete log-ins, registrations, and other activities. The game module 716 may also store or access a player's gaming history, such as player tracking and loyalty club account information. The game module 716 may provide static web pages to the player's device from the game module 716 through information flow 718, whereas, as stated above, the live game content may be provided from the gaming server 714 to the web game client 702 through information flow 711.

The gaming server 714 may be configured to provide interaction between the game and the player, such as receiving wager information, game selection, inter-game player selections or choices to play a game to its conclusion, and the random selection of game outcomes and graphics packages, which, alone or in conjunction with the downloadable game client 708/web game client 702 and game module 716, provide for the display of game graphics and player interactive interfaces. At information flow 718 player account and log-in information may be provided to the gaming server 714 from the account module 704 to enable gaming. Information flow 720 provides wager/credit information between the account module 704 and gaming server 714 for the play of the game and may display credits and eWallet availability. Information flow 722 may provide player tracking information for the gaming server 714 for tracking the player's play. The tracking of play may be used for purposes of providing loyalty rewards to a player, determining preferences, and the like.

All or portions of the features of FIG. 12 may be supported by servers and databases located remotely from a player's mobile device and may be hosted or sponsored by a regulated gaming entity for P2P gaming or, where P2P is not permitted, for entertainment only play.

In some embodiments, wagering games may be administered without players risking money in connection with the wagers (i.e., “play-for-fun” games). Access to play-for-fun wagering games may be granted on a time period basis in some embodiments. For example, upon initially joining the wagering game, each player may automatically be given nonmonetary wagering elements, such as, for example, chips, points, or simulated currency, that are of no redeemable value. After joining, the player may be permitted to place bets using the wagering elements and a timer may track how long the player has been participating in the wagering game. If the player exhausts his or her supply of the wagering elements before a predetermined period of time has expired, the player may be permitted to simply wait until the period of time passes to rejoin the game, at which time access to another quantity of the wagering elements may be granted to the player to permit the player to resume participation in the wagering game.

In some embodiments, a hierarchy of players may determine the quantity of wagering elements given to a player for each predetermined period of time. For example, players who have been participating in the wagering game for a longer time, who have played closest to optimal strategy for the game, who have won the largest percentage of wagers, who have wagered the most in a play-for-pay environment, or who have won the largest quantities of wagering elements from their wagers may be given more wagering elements for each allotment of time than players who have newly joined, who have played according to poor strategy, who have lost more frequently, or who have lost larger quantities of wagering elements. In some embodiments, the hierarchy of players may determine the duration of each allotment of time. For example, players who have been participating in the wagering game for a longer time, who have played closest to optimal strategy for the game, who have won the largest percentage of wagers, or who have won the largest quantities of wagering elements from their wagers may be given shorter allotments of times to wait for an award of more wagering elements than players who have newly joined, who have played according to poor strategy, who have lost more frequently, or who have lost larger quantities of wagering elements. In some embodiments, players who have not run out of wagering elements after the period of time has expired may have the balance of their wagering elements reset for a subsequent allotment of time. In other embodiments, players who have not run out of wagering elements may be allowed to retain their remaining wagering elements for subsequent allotments of time, and may be given additional wagering elements corresponding to the new allotment of time to further increase the balance of wagering elements at their disposal. Players may be assigned to different categories of players, which determine the number of wagering elements awarded. In a given period of time, higher level players, or players who have invested more time playing the game may be allotted more wagering elements per unit of time than a player assigned to a lower level group.

Therefore, in some embodiments, the wagering game may be administered by receiving wagers (e.g., the bonus and any other roulette wagers) of no real-world monetary value, and payouts (e.g., the payouts on the bonus and any other roulette wagers) may be paid without transferring real-world monetary value to the players. Such embodiments, referred to herein as “free play-for-fun” embodiments are nonetheless contemplated as modes of carrying out the methods described herein.

In some embodiments, referred to herein as “social play-for-fun” embodiments, a player may be permitted to redeem an access token of no redeemable face value, such as, for example, points associated with a player account (e.g., social media account credits, online points associated with a transacting account, etc.), to compress the period of time and receive more wagering elements. The access tokens may be sold or may be given without directly exchanging money for the access tokens. For example, access tokens may be allocated to players who participate in member events (e.g., complete surveys, receive training on how to play the wagering game, share information about the wagering game with others), spend time participating in the wagering game or in a player account forum (e.g., logged in to a social media account), or view advertising. Thus, an entity administering social play-for-fun wagering games may not receive money from losing player wagers or may not take a rake on wagers, but may receive compensation through advertising revenue or through the purchase of access tokens redeemable for time compressions to continue play of the wagering game or simply to increase the quantity of wagering elements available to a player.

After receipt of an indication that a player has stopped participating in a play-for-fun wagering game (e.g., a free play-for-fun embodiment, a social play-for-fun embodiment), any remaining quantities of the wagering elements may be relinquished by the player and retained by the administrator, in some embodiments. For example, receipt of an indication that the player has logged out of a play-for-fun wagering game administered over the Internet may cause any remaining wagering elements associated with a respective player to be lost. Thus, when the player rejoins the play-for-fun wagering game, the quantity of wagering elements given to the player for an allotment of time may not bear any relationship to the quantity of wagering elements held by the player when he or she quit playing a previous session of the wagering game. In other embodiments, upon receipt of an indication that a player has stopped playing, the quantity of wagering elements held by the player at that time may be retained and made available to the player, along with any additional quantities of wagering elements granted for new allotments of time, upon receipt of an indication that the player has rejoined the wagering game.

### EXAMPLE

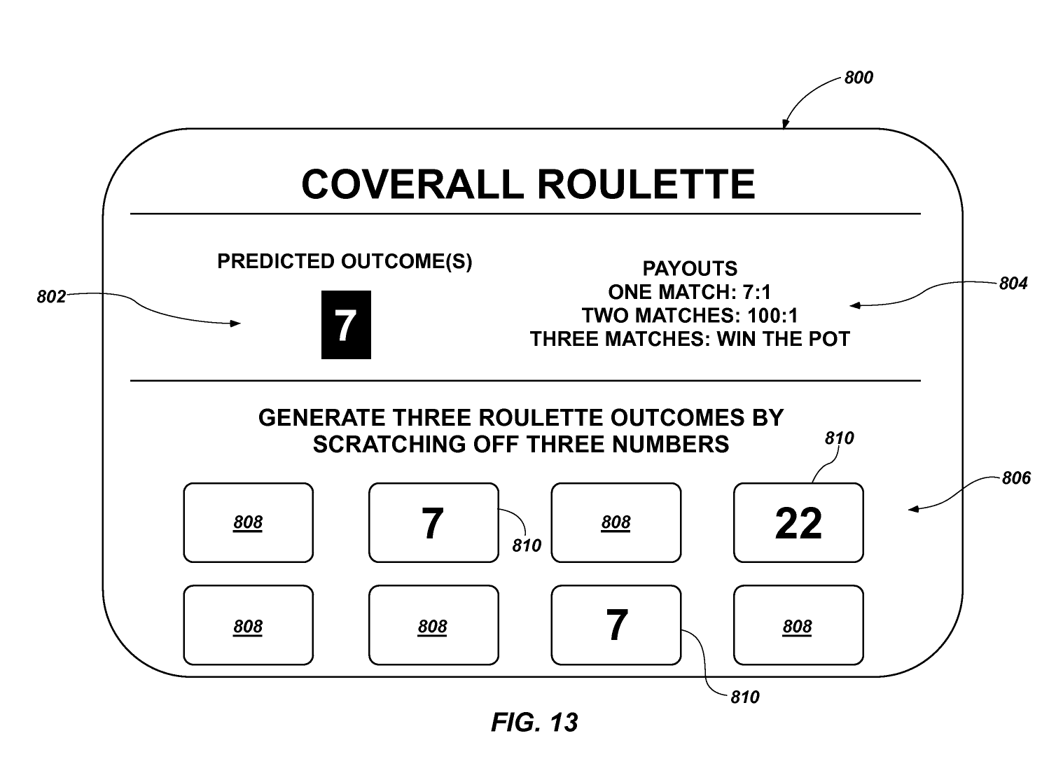

FIG. 13 is a schematic of a wagering game implemented as a scratch card 800. The scratch card 800 may include a predicted outcome area 802 in which acceptance of a wager and an indication of one or more predicted roulette outcomes may be reflected by, for example, printing the predicted roulette outcome or outcomes. The scratch card 800 may include a payout area 804 in which payout multipliers may be displayed. The scratch card 800 may include a roulette outcome generation area 806 in which scratch-off material 808 covering separate, randomized roulette outcomes may be located. When the scratch-off material 808 is removed, outcome areas 810 may be revealed, which outcome areas 810 may include roulette outcomes displayed therein.

When administering a wagering game in accordance with this disclosure implemented as a scratch card 800, a bonus wager may be accepted from a player, indication of a predicted roulette outcome may be received, and at least a portion of the bonus wager may be transferred to a progressive pot. For example, an authorized seller may accept monetary value from a player, may transfer at least a portion of the paid amount (e.g., a remainder of the amount after transferring a rake to the issuer of the scratch card 800) to a progressive pot account maintained by the issuer of the scratch card 800, may receive verbal selection of one or more roulette outcomes, and may enter the predicted roulette outcome or outcomes into a scratch-card-finalizing system. The amount by which the progressive pot may increase may be equal to the number of predicted roulette outcomes multiplied by a selected wagering amount (e.g., an amount fixed by the issuer of the scratch card 800 or a player-selected amount greater than an issuer-selected minimum, less than an issuer-selected maximum, or both) less any rake taken by the issuer. The predicted roulette outcome or outcomes may be fixed on the scratch card 800 and displayed in the predicted outcome area 802, such as, for example, by printing the predicted roulette outcome or outcomes onto the scratch card 800 using the scratch-card-finalizing system (e.g., a printer accepting scratch cards 800 with blank predicted outcome areas 802 as inputs).

A plurality of independently randomized roulette outcomes may be generated, such as, for example, by permitting the purchaser to scratch off the scratch-off material 808 covering three outcome areas 810. The bonus wager may be resolved by comparing each roulette outcome in the scratched-off outcome areas 810 to the predicted roulette outcome.

A payout on the bonus wager may be paid from the progressive pot to the player when at least one roulette outcome is the same as the predicted roulette outcome, such as, for example, by transferring wagering elements to a player, adding credits to a meter on a gaming device, or crediting funds credited to a player account. When there is no match between the predicted roulette outcome or outcomes and the three generated roulette outcomes, the amount of the bonus wager originally allocated to the progressive pot may remain in the progressive pot.

While certain illustrative embodiments have been described in connection with the figures, those of ordinary skill in the art will recognize and appreciate that the scope of this disclosure is not limited to those embodiments explicitly shown and described in this disclosure. Rather, many additions, deletions, and modifications to the embodiments described in this disclosure may result in embodiments within the scope of this disclosure, such as those specifically claimed, including legal equivalents. In addition, features from one disclosed embodiment may be combined with features of another disclosed embodiment while still being within the scope of this disclosure, as contemplated by the inventors.

What is claimed is:

1. A method of transforming a computing device into a wagering game administration endpoint, comprising:
accepting a wager from a player on a game of roulette by receiving authorization at a control circuit to allocate funds to the wager and receiving electronic indication of a predicted roulette outcome, the predicted roulette outcome being a number selected from a set of numbers;
generating electronic authorization at the control circuit to transfer at least a portion of the wager to a progressive pot;
generating a plurality of roulette outcomes, each roulette outcome being independently randomized;
resolving the wager by comparing each roulette outcome of the plurality of roulette outcomes to the predicted roulette outcome at the control circuit; and
generating electronic authorization at the control circuit to pay a payout on the wager from the progressive pot to the player when at least one roulette outcome is the same as the predicted roulette outcome, wherein an amount of the payout increases nonlinearly as a number of roulette outcomes matching the predicted roulette outcome increases.

2. The method of claim 1, wherein generating the electronic authorization at the control circuit to pay the payout on the wager to the player comprises generating the electronic authorization at the control circuit to pay a first payout on the wager from the progressive pot to the player when one of the plurality of roulette outcomes is the same as the predicted outcome, generating the electronic authorization at the control circuit to pay a second, greater payout on the wager from the progressive pot to the player when two of the plurality of roulette outcomes are the same as the predicted outcome, and generating the electronic authorization at the control circuit to pay an entire amount of the progressive pot to the player when all of the plurality of roulette outcomes are the same as the predicted outcome.

3. The method of claim 1, wherein generating the electronic authorization to transfer the at least a portion of the wager to the progressive pot comprises:
generating authorization at the control circuit to transfer a rake from the wager to a house account; and
generating authorization at the control circuit to transfer a remainder of the wager to the progressive pot.

4. The method of claim 1, wherein receiving electronic indication of the predicted roulette outcome comprises receiving electronic indication of a plurality of predicted roulette outcomes.

5. The method of claim 4, wherein receiving electronic indication of the plurality of predicted roulette outcomes comprises receiving electronic indication of each possible roulette outcome.

6. The method of claim 1, wherein generating the plurality of roulette outcomes comprises generating at least one of the plurality of roulette outcomes by introducing a physical outcome identifier into a physical, spinning roulette wheel, permitting the outcome identifier to come to rest on a roulette outcome, and conveying the roulette outcome to the control circuit.

7. The method of claim 1, wherein generating the plurality of roulette outcomes comprises generating at least one of the plurality of roulette outcomes utilizing a random number generator.

8. The method of claim 1, further comprising accepting a second roulette wager from the player on a predicted characteristic of one of the plurality of roulette outcomes and resolving the second roulette wager by comparing the predicted characteristic of the one roulette outcome of the plurality of roulette outcomes to an actual characteristic of the one roulette outcome of the plurality of roulette outcomes.

9. The method of claim 1, wherein receiving authorization at the control circuit, generating electronic authorization at the control circuit, and comparing at the control circuit comprise performing the recited acts utilizing a processor configured to execute computing instructions.

10. A gaming table for administering a wagering game, comprising:
at least one electronic display;
at least one memory;
at least one player input device;
at least one croupier input device; and
at least one control circuit programmed to:
accept a wager from the at least one player input device on a game of roulette by receiving electronic authorization to allocate funds to the wager and receive electronic indication of a predicted roulette outcome from the at least one player input device, the predicted roulette outcome being a number selected from a set of numbers;
generate authorization to transfer at least a portion of the wager to a progressive pot;
generate a plurality of roulette outcomes, and store each generated roulette outcome in the at least one memory, each roulette outcome being independently randomized;
resolve the wager by comparing each roulette outcome stored in the at least one memory to the predicted roulette outcome; and
generate electronic authorization to pay a payout on the wager from the progressive pot to the player when at least one roulette outcome is the same as the predicted roulette outcome, wherein an amount of the payout increases as a number of roulette outcomes matching the predicted roulette outcome increases.

11. The gaming table of claim 10, wherein the control circuit is a processor configured to execute computing instructions.

12. The gaming table of claim 10, wherein the plurality of generated roulette outcomes comprises three roulette outcomes.

13. The gaming table of claim 10, wherein the amount of the payout increases linearly as the number of roulette outcomes matching the predicted roulette outcomes increases.

14. The gaming table of claim 10, wherein the amount of the payout increases non-linearly as the number of roulette outcomes matching the predicted roulette outcomes increases.

15. The gaming table of claim 10, wherein the payout comprises a portion of the progressive pot.

16. The gaming table of claim 10, wherein the payout comprises the entire progressive pot.

17. A gaming table for administering a wagering game, comprising:
a playing surface comprising a betting layout;
a physical roulette wheel configured to spin and comprising a plurality of roulette outcomes distributed around the roulette wheel and at least one sensor configured to detect a roulette outcome generated by the roulette wheel;
at least one electronic display;
at least one croupier input device; and
at least one control circuit programmed to:
accept a wager from a player on a game of roulette by receiving electronic authorization to allocate funds to the wager and receive electronic indication of a predicted roulette outcome, the predicted roulette outcome being a number selected from a set of numbers;
generate authorization to transfer at least a portion of the wager to a progressive pot;
receive a roulette outcome detected by the at least one sensor of the roulette wheel, generate at least one additional roulette outcome, and store each generated roulette outcome in memory, each roulette outcome being independently randomized;
resolve the wager by comparing each roulette outcome to the predicted roulette outcome; and
generate electronic authorization to pay a payout on the wager from the progressive pot to the player when at least one roulette outcome is the same as the predicted roulette outcome, wherein an amount of the payout increases nonlinearly as a number of roulette outcomes matching the predicted roulette outcome increases.

18. The gaming table of claim 17, wherein the at least one control circuit is programmed to generate the electronic authorization to pay a first payout on the wager from the progressive pot to the player when one of the generated roulette outcomes is the same as the predicted outcome, to pay a second, greater payout on the wager from the progressive pot to the player when two of the generated roulette outcomes are the same as the predicted outcome, and to pay an entire amount of the progressive pot to the player when all of the generated of roulette outcomes are the same as the predicted outcome.

19. The gaming table of claim 17, wherein the at least one control circuit is programmed to:
generate authorization to transfer a rake from the wager to a house account; and
generate authorization to transfer a remainder of the wager to the progressive pot.

20. The gaming table of claim 17, wherein the control circuit is a processor configured to execute computing instructions.
